(19) United States
(12) Patent Application Publication
(10) Pub. No.: US 2025/0275050 A1
(43) Pub. Date: Aug. 28, 2025

(54) Sealed Plasma Torch

(71) Applicant: Standard BioTools Canada Inc., Markham (CA)

(72) Inventors: Adam CAREW, Markham (CA); Maxim VORONOV, Markham (CA); Alexander LOBODA, Markham (CA); Matthew Weel, Markham (CA)

(73) Assignee: Standard BioTools Canada Inc., Markham, ON (CA)

(21) Appl. No.: 18/858,552

(22) PCT Filed: Apr. 24, 2023
(86) PCT No.: PCT/IB2023/000242

§ 371 Date: Oct. 21, 2024

Related U.S. Application Data
(60) Provisional application No. 63/333,942, filed on Apr. 22, 2022.

(51) Int. Cl. H05H 1/28

(52) U.S. Cl. CPC H05H 1/28

(57) ABSTRACT

A sealed plasma torch assembly is described. In various embodiments, the sealed plasma torch completely separates the inert gas that flows inside the torch and forms the plasma from the surrounding air. In this way, the inert gas (e.g., argon) is not mixed with air. The sealed torch, in various embodiments, allows for better heat management, reduced consumption of gas, and a simpler and cheaper construction. The gas may be recirculated, further reducing consumption of gas. The reproducibility of analytical measurements using the plasma torch may be improved because the pressure of the plasma torch does not depend on atmospheric pressure. Methods of using the plasma torch are also described.

### RELATED APPLICATION

The present application claims priority to provisional application No. 63/333,942 filed on Apr. 22, 2023, which is herein incorporated by reference in its entirety.

### TECHNICAL FIELD

The present disclosure relates to plasma torches and, particularly, to novel sealed plasma torches for generating inductively coupled plasma (ICP) for use, e.g., in mass cytometry (ICP-MS) and optical emission spectrometry (ICP-OES).

### BACKGROUND

Plasma torches are employed for ionizing and/or exciting samples via exposure of the samples to an inductively coupled plasma. An example of an analytical inductively coupled plasma (ICP) torch is the open-air type, which includes Fassel-type torches. The Fassel-type torch includes three concentric quartz tubes inserted in a helical coil connected to a high voltage radiofrequency (RF) generator. Argon can be introduced via edges of the tubes, flowing into an induction zone where the plasma can be generated and maintained by the RF electro-magnetic field, followed by an analytical zone, where the sample atom ionization (for mass-spectrometry) or excitation (for optical emission spectroscopy) can be performed.

Subsequently, most of the argon is dissipated in the surrounding air, with a small portion (typically about 2 sLpm) sampled for mass spectrometry if applicable. The diameter of the torch is typically about 2 cm and the torch consumes about 1-1.5 kW of power and about 10-20 sLpm of argon, most of which is used to dissipate heat introduced into the plasma and to cool down the torch walls.

The open-air type torch has been used for spectro-analytical purposes for decades. The open-air type torch has challenges with a high consumption of argon used and high heat load. Operation of the open-air type torch may also be affected by conditions of the atmospheric air. Embodiments described herein address these and other difficulties.

### SUMMARY

In one aspect, a plasma torch assembly is disclosed, which comprises an envelope surrounding a plasma zone, a sampling chamber including a wall having at least one sampler orifice for providing a fluid communication between the plasma zone and the sampling chamber, and a seal for providing a sealed connection between the envelope and the wall of the sampling chamber around the at least one sampler orifice.

In various embodiments, the seal rigidly connects the envelope to the wall.

By way of example, the seal can include a groove formed in a surface of the sampler wall facing the plasma zone and a sealing element seated in the groove. Some examples of the sealing element can include an O-ring and a metal seal (e.g., a copper gasket).

The plasma torch assembly can include an injector that extends from a first inlet for receiving an injector gas to a first outlet for delivering at least a portion of the injector gas to the plasma zone. An injector gas supply can supply the injector gas to the injector. In various embodiments, the injector can have a truncated conical profile with the injector's outlet having a smaller cross-sectional area relative to the injector's inlet.

In various embodiments, the plasma torch assembly comprises a tubular structure positioned between the injector and an inner surface of the envelope and at least partially surrounding the injector so as to define a second inlet for delivering an auxiliary gas to a region between an outer surface of the injector and an inner surface of the tubular structure, said tubular structure further defining a third inlet for delivering a vortex gas to a region between an outer surface of the tubular structure and an inner surface of the envelope. The plasma torch assembly can include an auxiliary gas supply and a vortex gas supply for supplying the auxiliary gas and the vortex gas to the torch assembly.

In various embodiments, the injector gas, the auxiliary gas and the vortex gas can be the same gas, e.g., supplied via a single gas supply. In other embodiments, at least two of the injector gas, the auxiliary gas and the vortex gas can be different gases. A gas manifold can be configured to receive the gas from the single gas supply and distribute portions of the received gas as the injector, the auxiliary and the vortex gas.

In various embodiments, the plasma torch assembly can include at least one RF coil that is disposed at least partially around the envelope. The RF coil can be configured to allow igniting the plasma in response to application of an RF voltage thereto when a pressure in an interior of the torch envelope is less than about 4×10⁴ Pa, e.g., in a range of about 13 Pa to about 4×10⁴ Pa.

In various embodiments, the at least one RF coil can comprise two or more RF coils that are electrically connected in parallel. In various embodiments, the at least one RF coil has a split-coil structure having two or more segments that are mechanically coupled to one another so as to surround the torch envelope and are electrically coupled to provide an electrically conductive path between the two or more segments. In various embodiments, each of the coil segments can have a substantially semi-circular profile. In some such cases, the two segments can be mechanically coupled to fully surround the torch envelope.

In various embodiments, the at least one RF coil can be axially separated from the sampler orifice by a distance equal to or less than about ⅓ of diameter of the coil.

In various embodiments, the plasma torch assembly can include a radiofrequency (RF) source in electrical communication with the RF coil for generating an RF field within at least a portion of the plasma zone for igniting the plasma. The RF source can be configured to apply an RF voltage at a frequency in a range of about 900 kHz to about 10 GHz to the RF coil. By way of example, the RF voltage can have an amplitude in a range of about 50 V to about 6 kV.

The plasma torch assembly can further include at least one exhaust channel formed in the wall that extends from an inlet aperture to an outlet aperture, where the inlet aperture is in fluid communication with the plasma zone. At least one exhaust valve is operably coupled to the outlet aperture of the at least one exhaust channel for controlling an exhaust flow exiting the exhaust channel. At least one regulator can be coupled to the at least one exhaust valve for adjusting a flow rate of the exhaust exiting the exhaust channel. The regulator can be configured to adjust the exhaust flow rate so as to optimize flow of a plasma from the plasma zone into the sampler orifice.

By way of example, in various embodiments, the wall of the sampling chamber can support two or more exhaust channels. Two or more regulators operably coupled to the outlets of the exhaust channels can control the flow of the gas through the exhaust channels. The regulators can be configured to establish a differential flow rate in the exhaust channels so as to adjust the position of the plasma relative to the sampler's orifice. For example, the wall of the sampler can support two exhaust channels disposed on opposed sides of the sampler orifice. The flow rates of the exhaust gas through the channels can be adjusted to move the plasma along a first dimension, e.g., along a dimension (e.g., X-dimension) orthogonal to the longitudinal axis of the torch assembly. In some cases, two other channels can be provided in the wall so as to move the plasma along a second dimension. By way of example, the second dimension can be orthogonal to the first dimension. In various embodiments, more than two exhaust channels can be employed to adjust the position of the plasma via adjusting the flowrates of the exhaust gas through the exhaust channels.

A controller in communication with the regulators can send control signals to the regulators so as to adjust the flow rate of the exhaust gas through the respective exhaust channels, e.g., to optimize the flow of ionic and/or excited species generated in the plasma into the sampler orifice.

In various embodiments, first and second exhaust channels can be symmetrically positioned relative to the sampler orifice and the controller can control the regulators so as to provide substantially equal exhaust flow rates through the first and the second exhaust channels, e.g., to center the plasma relative to the sampler orifice.

In various embodiments, the torch assembly can include at least one recirculation path that is fluidically coupled to the at least one exhaust channel for returning at least a portion of the gas delivered to the plasma zone back to the plasma zone. In some such embodiments, a filter can be coupled to the recirculation path for filtering a gaseous effluent flowing from the plasma zone into the recirculation path prior to returning at least a portion of the gas to the plasma zone. Any suitable filter can be utilized. By way of example, and without limitation, the filter can be any of a charcoal filter and a molecular sieve filter, among others.

In various embodiments, the wall of the sampler supports at least one cooling channel that is configured to receive a coolant. The cooling channel can be fluidically isolated from the plasma zone, that is, no fluidic path connects the cooling channel with the plasma zone. A coolant supply in fluid communication with the at least one cooling channel can supply the coolant to the cooling channel.

In various embodiments, the injector has a length in a range of about 5 mm to about 50 mm. Further, in various embodiments, the torch envelope can have an inner diameter in a range of about 5 mm to about 30 mm.

The torch envelope can have a variety of different profiles (shapes). By way of example, the envelope can have a substantially cylindrical shape. In various embodiments, the torch envelope can have a varying cross-sectional dimension in a plane orthogonal to its longitudinal axis. By way of example, the torch envelope, can be in the form of a truncated cone.

The torch envelope can be formed of an electrically non-conductive material with a melting point of at least about 300° C. By way of example, and without limitation, the envelope can be formed from any of a ceramic (e.g., aluminum nitride, aluminum oxynitride, alumina, silicon nitride, sialon), glass, fused silica and sapphire.

In various embodiments, an axial distance between an outlet of the injector and the sampler orifice can be equal to or less than about 2 inner diameters of the torch envelope, e.g., in a range of about 5 mm to about 60 mm.

In various embodiments, the injector can be movable relative to the sampler orifice, e.g., in a plane orthogonal to a longitudinal axis of the torch assembly. For example, the injector can be mounted onto a movable platform. Further, in various embodiments, the injector can be movable along a longitudinal axis of the torch assembly so as to vary the axial distance between the injector's outlet and the sampler orifice.

The torch assembly can be enclosed in a housing. The housing can be formed of a metal, such as aluminum, copper, stainless steel, or metal plated plastic or metal plated ceramic. The thickness of the walls of the housing can be selected so as to protect the torch assembly from electromagnetic interference (EMI). Further, the housing can include one or more cooling channels for receiving a coolant.

In various embodiments, the torch assembly can be operated at an operating pressure greater than about 1×10⁵ Pa. For example, the operating pressure can be in a range of about 2×10⁵ Pa to about 1×10⁶ Pa.

In a related aspect, a plasma torch assembly is disclosed, which comprises an envelope surrounding a plasma zone in which a plasma is formed, a sampling chamber including a wall having at least one sampler orifice for providing a fluid communication between the plasma zone and the sampling chamber, a seal for providing a sealed connection between the envelope and the wall of the sampling chamber around the at least one sampler orifice, an injector positioned at least partially in the envelope and extending from an inlet for receiving an injector gas flow to an outlet through which the injector gas exits the injector, and a vortex generator in fluid communication with the plasma zone and configured to deliver a vortex gas flow into an interior of the envelope. The axial distance between the outlet of the injector and the sampler orifice can be in a range of about 5 mm to about 60 mm, e.g., in a range of about 10 mm to about 50 mm, or in range of about 20 mm to about 40 mm. In various embodiments, the outer surface of the injector and the inner surface of the envelope can be in direct fluid communication with one another, i.e., no structure is positioned between the outer surface of the injector and the inner surface of the envelope.

The envelope can have a profile that is configured to facilitate confinement of a plasma generated in the plasma zone via the vortex gas. By way of example, the envelope can have a tapered profile with a decreasing cross-sectional dimension as a function of decreasing distance from the wall. By way of example, the tapered profile of the sampler can be a truncated conical profile.

In various embodiments, the injector can have a tapered profile with the injector's outlet having a smaller cross-sectional area than that of the injector's inlet.

At least one RF coil can be disposed at least partially around the envelope. An RF voltage source can be in electrical communication with the RF coil for supplying an RF voltage thereto. By way of example, the RF voltage source can be configured to apply an RF voltage at a frequency in a range of about 900 kHz to about 10 GHz, e.g., in a range of about 1 MHz to about 1 GHZ, to the RF coil.

In a related aspect, a method for producing an inductively coupled plasma in a plasma torch having a torch envelope that is sealingly coupled to a wall of a sampler of an analytical instrument is disclosed, which includes introducing an inert gas into an interior of the torch envelope, maintaining a pressure of the interior of the torch envelope below about 4×10⁴ Pa, and establishing a radiofrequency (RF) field in at least a portion of the interior of the torch envelope so as to ignite a plasma in the gas.

Subsequent to the ignition of the plasma, the pressure within the torch envelope can be increased, e.g., to a pressure above 4×10⁴ Pa, e.g., a pressure in a range of about 1×10⁵ Pa to about 1×10⁶ Pa.

An injector can be utilized for introducing a sampler via a carrier gas into the plasma zone. Further, the position of the plasma relative to a longitudinal axis of the torch assembly can be adjusted by adjusting a tilt of the injector and/or its X-Y position relative to the longitudinal axis or both.

In various embodiments, the position of the plasma relative to a longitudinal axis of the plasma torch can be adjusted via adjusting the flow rate of an exhaust gas passing from the plasma zone or one or more exhaust channels provided in the wall of the sampler.

In various embodiments, at least a portion of the gas introduced into the interior of the torch envelope can be removed as an exhaust gas. The exhaust gas can be cooled, e.g., to a temperature less than about 100° C., e.g., while it passes through one or more exhaust channels formed in the wall of the sampler. In some cases, at least a portion of the exhaust gas is recirculated via a recirculation path back to the plasma zone. In various embodiments, the exhaust gas is filtered prior to its recirculation to the plasma zone.

Further understanding of various aspects of the embodiments may be obtained by reference to the following detailed description in conjunction with the associated drawings, which are described briefly below.

### BRIEF DESCRIPTION OF THE DRAWINGS

The drawings are not necessarily to scale or exhaustive. Instead, emphasis is generally placed upon illustrating the principles of the embodiments described herein. The accompanying drawings, which are incorporated in this specification and constitute a part of it, illustrate several embodiments consistent with the disclosure. Together with the description, the drawings serve to explain the principles of the disclosure.

In the drawings:

FIG. 1A shows an example of a plasma torch assembly according to embodiments of the present embodiments,

FIG. 1B shows a cross-sectional cut through an image of a wall of a sampling chamber, such the wall discussed above in connection with FIG. 1A,

FIG. 1C is a partial schematic view of three RF coils that are electrically connected in parallel and have a split-coil structure,

FIG. 1D is a schematic view of both components of each of the RF coils, where the components are mechanically coupled so that each of the RF coils surround the torch envelope,

FIG. 2 shows an example of a plasma torch assembly providing recirculation of a gas introduced to the torch assembly back to plasma zone according to embodiments of the present invention.

FIG. 3A shows a schematic axial view of the sampler orifice and the inlet apertures of two exhaust channels positioned symmetrically on opposed sides of the sampler orifice along the X-direction, where the gas flowrates through the exhaust channels can be adjusted to move the plasma along the X-direction,

FIG. 3B shows a schematic axial view of the sampler orifice and four inlet channels associated with four exhaust channels, where two of the inlet apertures are symmetrically positioned on opposed sides of the sampler orifice along the X-direction and two of the inlet apertures are symmetrically positioned on opposed sides of the sampler orifice along the Y-direction such that adjusting the gas flowrates through the pair positioned along the X-direction allows adjusting position of the plasma along the X-direction and adjusting the gas flowrates in the two exhaust channels positioned along the Y-direction allows independent adjustment of the plasma position in the Y-direction,

FIGS. 4A and 4B show positioning of a plasma by adjusting exhaust flow rates through a plurality of exhaust channel distributed about the sampler orifice for adjusting the position of the plasm relative to the sampler orifice, according to embodiments of the present invention.

FIG. 4C schematically depicts a movable platform on which an injector is mounted,

FIG. 4D schematically depicts an example of a housing in which a torch assembly according to various embodiments can be housed, sharing the enclosure with RF generator circuitry.

FIGS. 5A-5C are schematic cross-sectional views of examples of torch assemblies according to embodiments in which an auxiliary gas flow is not utilized,

FIGS. 6A and 6B show examples of a sealed plasma torch assembly according to embodiments of the present invention,

FIG. 7 shows a flowchart of an example process associated with examples of methods of analysis using a sealed plasma torch according to embodiments of the present invention,

FIG. 8 shows an example of parts of a sealed plasma torch assembly according to embodiments of the present invention,

FIG. 9 shows a schematic diagram of a sealed torch assembly according to embodiments of the present invention,

FIG. 10 shows a schematic diagram of a sealed torch assembly according to embodiments of the present invention,

FIG. 11 shows a schematic diagram of a sealed torch assembly according to embodiments of the present invention,

FIG. 12 shows a schematic diagram of a sealed torch assembly according to embodiments of the present invention,

FIG. 13 shows a schematic diagram of a sealed torch assembly according to embodiments of the present invention, and

FIG. 14 shows a schematic diagram of a sealed torch assembly according to embodiments of the present invention.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that various embodiments of the applicant's teachings may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

The following detailed description refers to the accompanying drawings. The same or similar reference numbers may have been used in the drawings or in the description to refer to the same or similar parts. Also, similarly named elements may perform similar functions and may be similarly designed, unless specified otherwise. Details are set forth to provide an understanding of the exemplary embodiments. Embodiments, e.g., alternative embodiments, may be practiced without some of these details. In other instances, well known techniques, procedures, and components have not been described in detail to avoid obscuring the described embodiments.

Various terms are used herein in accordance with their ordinary meanings in the art. The term “a seal” as used herein refers to a device and/or substance that is used to join two structures together. The term “a sealed connection” refers to a connection made between two structures using a seal, where a leakage, if any, through the connection is less than about 0.1 sLpm, or less than about 0.05 sLpm, or less than about 0.01 sLpm. The terms “plasma gas flow” and “vortex gas flow” are used herein interchangeably to refer to a gas introduced into an envelope of a plasma torch through an inlet other than the inlet of an injector, which is in utilized to introduce a gas and a sample into the plasma torch. A “vortex gas flow” may or may not include any vortices as it flows through the plasma torch. The term “rigid sealed connection,” as used herein, refers to a sealed connection that cannot be moved without breaking the seal. The term “axial distance,” as used herein, refers to a distance between two components/elements of the torch assembly along a longitudinal axis thereof. The “axial distance between a coil and an orifice of a sampler” refers to the minimum axial distance between the turns of the coil and the sampler orifice.

In an open-to-air type inductively coupled plasma (ICP) torch, an inert gas (e.g., argon) is introduced, e.g., via quartz or ceramic tubes, into the torch. The gas then flows into an induction zone where a plasma is excited by a load coil connected to an RF generator. The gas then exits the torch and is largely dissipated in the surrounding air. The open-air type torch does not separate plasma gas from the surrounding air. As such, the heat introduced into the plasma gas in the induction zone is dissipated mostly in the surrounding air. The plasma gas can also heat a sampler through which ions or excited species generated in the plasma zone are introduced into a downstream analytical instrument, e.g., a mass spectrometer.

In the open-air type torch, mixing of the exhaust argon and the surrounding air can cause some problems. First, air can diffuse into the analytical zone, i.e., a region in front of the sampler orifice, and increase the amount of gaseous contaminants, such as oxides, in the analytical flow. Second, before ignition of the plasma, air also migrates into the torch. This can result in difficulties at ignition. Often several sparks must be applied in order to ignite the plasma. Third, the mixture of the hot plasma gas with air causes formation of harmful molecules like excited or ionized N₂, O₂, NOx and/or O₃. Both the oxide and air contaminants may be visible in mass spectra or other analytic techniques. To remove the harmful molecules, an enclosed duct exhaust system may be used, with relatively large air flow of about 2000-4000 sLpm. An exhaust system with such requirements can be expensive to install and maintain.

Additional problems related to the open-air type ICP torch include a high heat load imposed on the system by the plasma. Water cooling (or other liquid cooling) of open-air type ICP torches can pose certain challenges. Analytical results of water-cooled torches may be less precise. Water cooling may result in overcooling of the ICP torch. Further, a complex construction may be needed for water cooling. Moreover, water cooling bears the risk of water leakage into the high voltage zone. In addition, electrical power may leak through the water if the water is contaminated, which is likely because the cooling water becomes contaminated with time.

Open air-type torches may allow adjustment between the center of the analytical zone and the intake opening of the sampler. The air gap between the torch and an ion sampler of an analytical instrument can facilitate free movement of the torch assembly, which in turn moves the center of the analytical zone against the stationary position of the sampler orifice. However, the implementation of such X-Y adjustment mechanism can be complex. These matters are further complicated by the need to maintain RF EMI (electromagnetic interference) seal between the torch housing and the sampler.

Furthermore, a Fassel-type, and many other torch types, consume large amounts of argon gas (or any other gas that is used for generating the plasma). A mass spectrometry setup incorporating an open-air type torch may also use a gate valve in the vacuum interface, which complicates ion optics in the plasma-mass analyzer transition. Although vacuum systems of analytical instruments that employ open-air plasma torches can handle the gas flow throughput when the plasma is on (e.g., because the high temperature of plasma lowers the density of the flowing gaseous species), when the plasma is off, the flow of air through the sampler orifice can exceed the pumping throughput of the vacuum system.

In contrast, in a sealed torch according to various embodiments of the present teachings, in absence of a plasma, the pressure in the plasma zone can drop, thus limiting the amount of gas flowing into the vacuum system. In various embodiments, a sealed torch arrangement not only simplifies the vacuum system and offers additional flexibility for ion optics elements, but it also simplifies software- and firmware-based handling of vacuum gate valves and interlocks, which can transition the gate valves into a closed state when the plasma is off.

When the plasma is not ignited, air may migrate into the flow of the inert gas used for generating the plasma. Igniting a plasma of a mixture of the inert gas and air may be more difficult than igniting a plasma in a pure inert gas such as argon. A plasma for an open-air type torch may be ignited by dedicated electrodes, which are not used after the plasma is ignited. This ignition mechanism may use electronics to control the electrodes, increasing complexity and cost of the system.

The ignition electrodes, and the mechanical X-Y adjustment construction limit the possible miniaturization of the size of the torch, particularly its length. The mixing of the surrounding air with the plasma means that the ICP pressure would depend on the atmospheric pressure. Additionally, high mechanical vibrations may be caused by cooling fans that are used to cool down the system heated by the plasma.

### I. Sealed Torch

Embodiments described herein include a sealed ICP torch that separates and isolates the inert gas that flows inside the torch, and forms the plasma, from the surrounding air. For example, in various embodiments, a seal is employed to establish a sealed connection between the torch and a wall of a sampler utilized to introduce ions and/or excited species generated in a plasma zone of the torch into an analytical instrument.

By way of example, in various embodiments of the sealed torch, an outer quartz torch envelope is extended to the sampler, and the junction between the distal end of the envelope and a wall of the sampler is sealed. In this way, the inert gas (e.g., argon) is not mixed with air.

Because the inert gas and the heat introduced in the plasma are not dissipated in air anymore, in various embodiments, the sealed torch may be complemented by a special liquid-cooled sampler that includes channels to remove the inert gas from the torch and to remove the plasma heat that is either carried by the plasma gas or is transferred as heat to the sampler surface. In various embodiments, liquid cooling may include water and/or glycol, by way of example. Other heat removal mechanisms, such as heat pipes, heat spreaders, and evaporative chillers can be also used to transfer the heat away from the plasma region.

In various embodiments, a sealed plasma torch can provide many advantages. The consumption of a significant amount of the plasma heat by the sampler can advantageously decrease the heat load on other elements of the system. It can also facilitate the handling of the exhaust gas. The isolation of the plasma from the surrounding air can reduce the formation of oxides, and hence their detection in mass-spectra of ions generated via passage through the plasma. Further, in various embodiments, a sealed plasma torch according to the present teachings can provide better control of gaseous contaminants in mass spectra, such as xenon, lead, and mercury, which are commonly associated with impurities in the air.

While in various embodiments a seal providing a sealed connection between the plasma torch and the sampler may be implemented as a movable seal that would allow adjusting the position of the torch axis relative to an orifice of the sampler, in many embodiments the seal provides a rigid sealed connection between the torch and the sampler, which can eliminate the engineering challenges associated with the implementation of a movable seal. Such a rigid connection does not allow movement of the torch envelope relative to the sampler, e.g., to align the torch axis with the sampler's orifice.

To address the alignment of the plasma torch relative to the sampler's orifice, in various embodiments, alternative systems and methods for spatial positioning and/or adjustment of the plasma, e.g., in an X-Y plane perpendicular to a longitudinal axis of the plasma torch, can be employed, e.g., for optimizing the transfer of ions or excited species generated within the plasma to the sampler's orifice.

In one such method, the parts are made to tolerance and precision such that no further X-Y adjustment is needed. In various embodiments, the adjustment of the plasma, e.g., the adjustment of the plasma along directions in the X-Y plane, can be performed by adjusting the position, e.g., the X-Y position, or the tilt angle of an injector utilized to introduce a gas and a sample into the plasma torch.

In various embodiments, the X-Y adjustment of the plasma may be performed via exhaust gas flow control rather than a mechanical adjustment. For example, the conductance of different gas output lines can be adjusted. This gas flow control adjustment is unique to the sealed torch configuration. By way of example, the flow rates of an exhaust gas flowing through two exhaust channels that are symmetrically disposed on opposed sides of the sampler orifice can be adjusted to move the plasma in the X-Y plane, as discussed in more detail below.

In various embodiments, the exhaust flow rate associated with a sealed plasma torch according to the present teachings may be only about 10-20 sLpm, e.g., of argon being exhausted, in comparison with open-air type torches where the argon gas flow is mixed with a flow of cooling air typically amounting to 2,000-4,000 sLpm (60-120 scfm) of flow. Further, in various embodiments, the argon gas is cooled as it passes through the exhaust channel(s), e.g., via conductive cooling provided by one or more cooling channels formed in the sampler wall. The lower exhaust flow together with the cooling of the exhaust gas provides new opportunities for handling the exhaust flow.

In various embodiments, at least a portion of argon (or any inert gas used in the plasma) exhausted through the exhaust flow channels in the sampler can be reintroduced into the plasma, reducing in many cases the total argon consumption to only the amount that is sampled into an analytical instrument, e.g., a mass spectrometer, via the sampler orifice (typically about 2 sLpm). Further, in various embodiments, at least a portion of the gas passing through the sampler orifice can be captured and recirculated back to the plasma zone. In various embodiments, virtually all gas flow (e.g., at least about 90%, or at least about 95%, or at least about 99%) can be captured, including both exhaust and sampler flows, filtered and recirculated allowing for torch envelope to operate without the need for an appreciable gas supply for days or even weeks.

In various embodiments of a sealed plasma torch according to the present teachings a gate valve in the vacuum chamber may not be needed, simplifying the vacuum system and reducing the instrument cost and complexity. In such embodiments, the elimination of the gate valve is possible because the flow of gas in the sealed torch can be controlled. For example, when the plasma is off, the orifice in the sampler can conduct a large amount of gas into the vacuum through the sampler orifice. In absence of a sealed connection between the plasma torch and the sampler, such a flow could overwhelm the vacuum pumping systems requiring the use of the gate valve. But, with a sealed torch in accordance with various embodiments, the amount of gas flowing into the torch can be controlled by mass flow controllers. Thus, the amount of gas that would load the vacuum system can also be controlled and can be kept within the capacity of the pumping system.

In various embodiments, a sealed plasma torch according to the present teachings does not include conventional ignition electrodes and their electronics because the plasma in the sealed torch can be self-ignited by RF fields alone at low pressures. In particular, the RF field generated by one or more RF coils surrounding the envelope can generate RF fields that can cause the ignition of the plasma but at a low pressure, e.g., a pressure in a range of about 0.1 Torr (about 1.3 Pa) to about 300 Torr (about 4×10⁴ Pa), but also maintain the plasma as the pressure in the plasma zone is increased, e.g., to atmospheric pressure or above, subsequent to the ignition of the plasma. This, in turn, enables the use of a shorter plasma vessel (torch) and allows for the injector length to be reduced. A reduced injector length then allows for faster transit of ablation plumes along a path through which the ablation plumes travel from the laser ablation spot, including through the injector's conduit, to the plasma, leading to the transients approaching 100 μs, enabling pixel rate of 10 kHz. In combination with a compact RF generator (including one built on solid state components), an extremely short injector is possible. This results in faster arrival of laser ablation plumes in the plasma and consequently less broadening of the resulting plume transient.

Because the torch assembly is sealed from the atmosphere, the ICP pressure does not depend on the atmospheric pressure at a given location. This enhances reproducibility of the measurements (e.g., a change in weather will no longer influence ion signals) and makes measurements independent of the altitude of the instrument installation site.

Further, because in various embodiments almost all the plasma heat is transferred to the sampler, there is a significant reduction of hot air exhaust, and hence the heat load on the benchtop system can be managed more easily. In various embodiments in which the sampler includes cooling channels in which a coolant flows, the heat from the plasma is mainly dissipated by the coolant flow. This coolant flow may be managed by a cooler or a chiller that is independent of the benchtop system. The remaining heat in the benchtop system is thus minimized. This in turn relaxes thermal requirements for the instrument design. For example, the enhanced heat dissipation provided by a sealed plasma torch assembly according to various embodiments can reduce the number of mechanical fans in the system and therefore reduce vibrations, which provides an advantage for integrated laser ablation/mass cytometry systems used for imaging applications.

Additionally, a sealed torch assembly according to various embodiments may stabilize the time required for samples to arrive at the plasma (e.g., from an ablation cell). The flow rate through a transfer tube (usually specified to be a certain flow in sLpm) of a plasma torch may depend on the discharge pressure. Thus, in an open-air type torch, the transit speed of the ablated material through the injector depends on ambient atmospheric pressure conditions, while in a sealed torch, the transit speed does not because the sealed torch is isolated from the surrounding environment. Therefore, in various embodiments, a sealed torch can provide enhanced stability in imaging applications because the stability of the time of arrival of a sample (e.g., ablated materials) may directly affect the fidelity of the imaging data.

### Example Torch Assembly

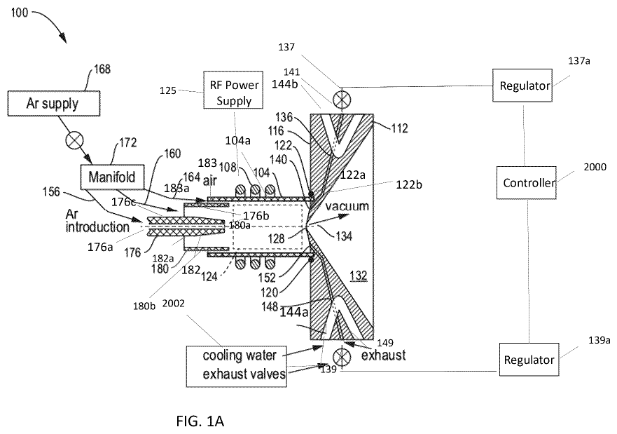

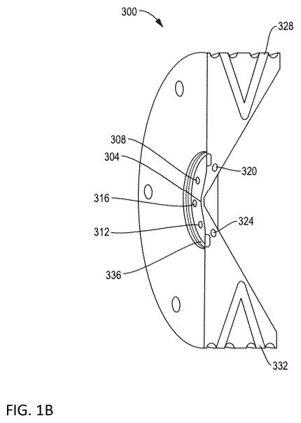

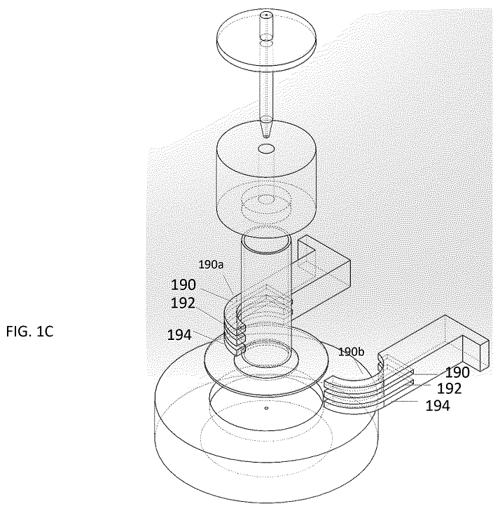

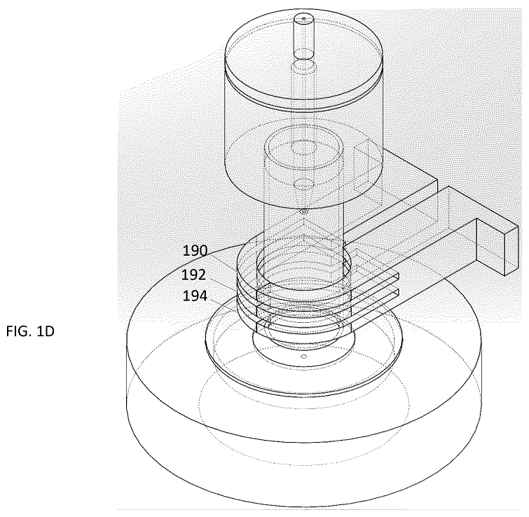

FIG. 1A schematically shows an example of a plasma torch assembly 100 according to an embodiment, which includes a torch envelope 104 providing an enclosure for housing various components of the torch assembly, as discussed below. By way of example, torch envelope 104 can be in the form of a tubular structure with a variety of different profiles. In some embodiment, the torch envelope 104 may be in the form of a cylindrical tube, a truncated cone, a trumpet-like shape, or any other suitable shape, including a shape formed by revolving a profile, a parabola, around an axis of symmetry.

Plasma torch assembly 100 further includes a sampling envelope 112 having a wall 116, where the wall 116 includes a surface 120 that is in sealing contact with the torch envelope 104, as discussed in more detail below.

Further, torch envelope 104 may have a variety of inner diameters. While in various embodiments, e.g., when the torch envelope is a cylindrical tube, the inner diameter of the torch envelope can be substantially uniform along its length, in other embodiments, the inner diameter of the envelope can vary along its length (e.g., in the case in which the envelope is in the form of a truncated cone). The variation of the inner diameter may be described by a linear or non-linear equation based on a position along a longitudinal axis (e.g., x¹ or x², where x is the distance along the longitudinal axis of the torch assembly).

Torch envelope 104 may be formed of any suitable electrically non-conducting material that can withstand the temperatures to which it is exposed during the operation of the plasma torch assembly. Some examples of suitable materials include, for example, glass (e.g., quartz) or ceramic, such as aluminum nitride, or other suitable materials.

In various embodiments, torch envelope 104 may have a diameter in the range of about 0.5 to about 1 cm, or about 1 to about 3 cm, or about 3 to about 5 cm, or about 5 to about 10 cm, or greater than about 10 cm, e.g., in a range of about 10 cm to about 30 cm. By way of further examples, torch envelope 104 may have a length in the range of 1 to 3 cm, 3 to 5 cm, 5 to 10 cm, 10 to 20 cm, 20 to 30 cm, 30 to 50 cm, or over 50 cm.

In this embodiment, plasma torch assembly 100 may include a coil 108 (herein also referred to as an RF coil) that is disposed around torch envelope 104. A power supply 125 generating RF power is in electrical communication with the coil 108 for supplying power to the coil so as to generate an RF electromagnetic field within a plasma zone of the torch assembly for facilitating the generation of a plasma and its maintenance during operation of the plasma torch assembly.

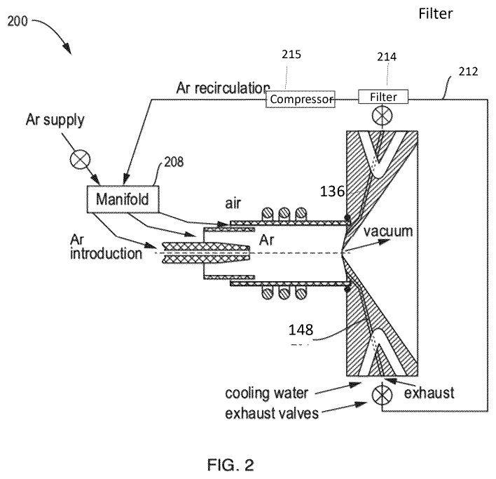

Conventionally, it is believed that an RF coil utilized in a plasma torch assembly should be positioned at a sufficient distance relative to a sampler envelope so as to allow the magnetic flux lines generated by the coil to form closed loops. However, as disclosed herein, it has been discovered that in various embodiments of a sealed torch assembly according to the present teachings, the RF coil can be positioned relative to the sampler envelope such that an axial distance (D) between the coil and the sampler orifice (See, FIG. 2) is equal to or less than about ⅓ of the coil's diameter. By way of example, the axial distance between the RF coil and the sampler orifice can be in a range of about 1 mm to about 20 mm. The ability to place the RF coil close to the sampler orifice can allow for a more compact construction of the torch assembly.

By way of example, the power supply may be configured to deliver a voltage at a frequency in a range of about 1 MHz to about 10 GHz, e.g., in a range of about 1 MHz to about 300 MHz, such as 27.12 MHz and 40 MHz, to the coil. The amplitude of the voltage may be, for example, in a range of about 50 V to about 6 kV, e.g., in a range of about 300 V to about 6 kV. While in various embodiments coil 108 may be a single coil that is helically wound around the torch envelope, in some other embodiments, a plurality of coils that are electrically connected in parallel may be used. Further, in various embodiments, the coil 108 can have a split-coil structure with two or more segments that are mechanically coupled to one another so as to surround the torch envelope and are electrically coupled to provide an electrical path between the two segments. Coil 108 may be any load coil described herein or any known load coil.

In various embodiments, multiple RF coils that are electrically connected in parallel can be employed. By way of example, FIG. 1C schematically depicts three coils 190, 192, and 194 that are electrically connected in parallel. One advantage of using a plurality of coils that are connected in parallel is that a lower voltage can be utilized for generating the required RF field.

With reference to FIGS. 1C and 1D, in this embodiment, each of the coils 192, 194, and 196 has a split structure including two components/segments, such as 190a and 190b, that can be mechanically connected to surround the torch envelope. Further, the two components of each of the coils are electrically connected to allow passage of a current between them. Although in this embodiment each coil is formed of two components, in other embodiments one or more coils utilized as RF coils may have a split-coil structure including more than two components.

Referring again to FIG. 1A, wall 116 may be made of a heat conducting material, such as copper. In this embodiment, surface 120 forms a sealed connection with torch envelope 104. For example, an O-ring 122b seated in a groove 122a formed in the surface 120 provides a seal 122 for establishing a sealed connection between the plasma torch and the wall 116. Other types of seals, such as metal seals, e.g., a copper or aluminum gasket, welded or brazed seal, or a glued seal, may also be employed. In fact, any suitable seal that can provide a desired sealed connection between the torch envelope and the wall of the sampler may be utilized. As discussed in more detail below, a sealed connection between the torch envelope and the wall of sampler can provide several advantages.

A portion of the surface and torch envelope can define a plasma zone 124 (herein also referred to as an inductive zone) in which the inductively coupled plasma can be generated. The shape of plasma zone 124 is illustrated approximately in the figure, but the shape is shown only for illustration purposes and the plasma zone 124 may take other shapes.

In various embodiments, surface 120 may define one or more apertures, which can provide fluid communication between the plasma zone and one or more channels formed in the wall 116, e.g., exhaust channels. The number of apertures provided in surface 120 can be, for example, in a range of 2 to 5, 5 to 10, 10 to 15, 15 to 20, or over 20 apertures. In various embodiments, the plurality of apertures may be distributed uniformly in the space circumscribed by torch envelope 104. By way of example, the plurality of apertures may be distributed in a radially symmetric pattern. In various embodiments, surface 120 may define a single aperture, which may accommodate all flow from the plasma.

In this embodiment, a first aperture 128 (herein also referred to as a sampler orifice) of the plurality of apertures may fluidically connect a sampling chamber 132 defined by sampling envelope 112 with plasma zone 124. First aperture 128 is disposed on a longitudinal axis 134, which extends along the center of torch envelope 104. First aperture 128 may be in the center of wall 116 circumscribed by torch envelope 104. First aperture 128 may be considered a sampler orifice or a sampler through which analytes ionized or excited in the plasma zone can be transferred to a downstream analytical instrument, such as a mass spectrometer or an optical emission spectrometer.

Longitudinal axis 134 may be orthogonal to wall 116, including surface 120 of wall 116. In various embodiments, wall 116 may define a conical space with the sampler orifice 128 at one end of the conical space. Sampling chamber 132 may be the conical space. First aperture 128 may have its smallest diameter in a range from about 0.1 to about 0.2 mm, about 0.2 to about 0.3 mm, about 0.3 to about 0.4 mm, about 0.4 to about 0.5 mm, about 0.5 to about 1 mm, about 1 to about 2 mm, or over about 2 mm.

Sampling chamber 132 may be in fluid communication with a pump, which may also be part of the plasma torch assembly 100. Because of the sealed connection, plasma zone 124 is not exposed to atmospheric air when the pump is running and sampling chamber 132 is at a vacuum pressure or at higher pressures, e.g., one atmosphere.

The pressure upstream in plasma zone 124 can be higher (e.g., from 1 to 10 atm, including 1.2 atm). In various embodiments, the pressure gradient between plasma zone 124 and sampling chamber 132 creates a plasma jet that flows into sampling chamber 132, where an apparatus for analysis of this jet can be installed. In the case of optical emission spectroscopy (OES), that apparatus can operate at 1 atm, if needed. OES can also operate at 0.1 atm of pressure difference between zone 124 and zone 132. And, in the case of ICP mass spectrometry (ICP-MS), the pressure in the sampling chamber may be as sufficiently low as required by the mass analyzer (e.g., 3 Torr in the first section of zone 132). The pressure in the ICP-MS sampling chamber is typically not uniform. Multiple vacuum compartments may be used in mass spectrometry to facilitate differential pumping and gradual reduction of pressure to a level where ions can be mass analyzed and detected.

In various embodiments, one or more channels can be formed in wall 116 that are in fluid communication with the plasma zone to receive an exhaust flow (e.g., one or more gases introduced into the plasma torch and/or plasma effluents). In various embodiments, the exhaust flow can be at least partially returned, e.g., after appropriate filtration, to the plasma zone. In other embodiments, the exhaust flow can be directed to an exhaust system, e.g., a fume hood. In various embodiments, the exhaust gas can be either compressed or liquified, e.g., via directing the exhaust flow to a compressor or a liquefier station, and the compressed or liquified exhaust gas can be stored and utilized in applications in which the use of a lower grade of the gas is acceptable. For example, in some laser ablation imaging cytometry configurations, after a single pass, the contamination of the inert gas (e.g., argon) is typically below about 2 ppm in dry plasma mode. At such low contamination of impurities, the gas would be still usable for a variety of applications, for example, in some welding applications.

The use of a sealed torch allows cooling the exhaust gas as well as reducing the flow rate of the exhaust gas, e.g., via at least partial recirculation of the exhaust gas back to the plasma zone, thereby allowing disposing the remaining exhaust flow using much more economical ways than possible in conventional plasma torch assembly that are open to atmospheric pressure. By way of example, the cooling of the exhaust gas in various embodiments of a torch assembly according to the present teachings can reduce the gas temperature to less than about 100° C., whereas the exhaust gas in conventional torch assemblies can exhibit temperatures that are at least one order of magnitude higher before the plasma gas mixes with air and cools down. Further, in various embodiments, the flow rate of the exhaust gas in a torch assembly according to the present teachings can be as low as about 15 sLpm, whereas the exhaust flow rate in conventional plasma torch assemblies can be around 150 times higher because the hot plasma gas is diluted by air to cool it down before being directed to the exhaust tubing. The ability to operate a torch assembly according to various embodiments at a low exhaust flow rate provides convenient and low-cost ways of handling the exhaust, e.g., via directing the exhaust flow to a conventional fume hood.

Referring again to FIG. 1A, in this embodiment, wall 116 defines a first channel 136 having an inlet aperture 140 (herein also referred to as the second aperture 140) of the plurality of apertures that provides fluid communication between first channel 136 and plasma zone 124. In this embodiment, first channel 136 can function as an exhaust channel by receiving gas(es) and other plasma effluents from the plasma zone via the inlet aperture 140. The first channel 136 includes an outlet aperture 141 through which the exhaust flow exits the channel. In this embodiment, the exhaust flow is received by an exhaust system, e.g., a fume hood, that disposes of the exhaust flow without returning the exhaust (or a portion thereof, e.g., the gas employed for generating the plasma) back to plasma zone 124.

In this embodiment, wall 116 defines another channel 148 that is in fluid communication via an inlet aperture 152 with the plasma zone 124. Similar to channel 136, the channel 148 can also function as an exhaust channel. In particular, channel 148 includes an outlet aperture 149 through which the exhaust flow can exit channel 148.

Each channel 136 and 148 may also function as a recycle channel for returning at least a portion of the inert gas(es) in the exhaust flow, e.g., after filtration, to the plasma zone, as discussed in more detail below. The flow in each of channels 136 and 148 can be independently controlled via two valves 137 and 139, respectively. Regulators 137a and 139a in communication with the outlets of channels 136 and 148 can adjust the valves to control the flow rates through channels 136 and 148, respectively. A controller 2000 is in communication with the regulators to send control signals to the regulators for controlling operation thereof.

In this embodiment, wall 116 defines cooling channels 144a/144b that are formed within the wall 116 and are in communication with a cooling unit 1002, which includes a coolant supply (e.g., water, glycol, and/or other coolants) and can provide a recirculating flow of the coolant to the channels 144a/144b. Neither channel 144a nor channel 144b is in fluid communication with the plasma zone, i.e., the two channels are fluidically isolated from the plasma zone.

The flow of the coolant through the cooling channels 144a and 144b results in cooling of the wall 116 as well as the exhaust flowing through the exhaust channels 136 and 148. As noted above, the cooling of the exhaust can advantageously reduce its temperature, which can in turn allow handling of the exhaust in ways that are not practical in conventional systems.

In this embodiment, torch envelope 104 is rigidly coupled to wall 116 of sampling envelope 112. In particular, an O-ring seal 122 including a groove 122a formed in the wall 116 in which an O-ring 122b is seated provides a rigid sealed connection between wall 116 and the torch envelope 104. While in conventional systems a gap between the torch envelope and the wall of a sampling chamber allows the leakage of gases to the external environment, in this embodiment there is no gap between the torch envelope and the wall 116 and the O-ring seal 122 prevents such a leakage. The rigid connection also simplifies the connection of the plasma torch to the wall of the sampling chamber. Further, the sealed connection between the torch envelope and the wall of the sampling chamber allows operating the plasma at pressures other than the atmospheric pressure. Such flexibility provides certain advantages. For example, prior to ignition of the plasma, the pressure within the plasma torch can be reduced, e.g., to a pressure in a range of about 0.1 Torr to about 300 Torr (corresponding to a pressure in a range of about 13.3 Pa to about 40,000 Pa) to allow the use of an RF coil to ignite the plasma without any need for conventional ignition coils. Once the plasma is ignited, the pressure within the plasma torch can be increased while the RF radiation generated by the RF coil provides sufficient power to sustain the plasma. By way of example, and without limitation, the pressure in the plasma zone can be increased to 1 atm or higher, such as 2 or 3 atm (2×10⁵ or 3×10⁵ Pa).

Thus, in this embodiment, torch envelope 104 is rigidly coupled with respect to apertures 128, 140, 152, and/or wall 116. Torch envelope 104 may be in direct contact with O-ring 122, wall 116, and/or sampling envelope 112. O-ring 122 may be in direct contact with sampling envelope 112. Rigid coupling between torch envelope 104 and sampling envelope 112 does not allow movement of the torch envelope 104 relative to sampling envelope 112 without breaking the sealed connection. For example, in various embodiments, the torch envelope 104 is not coupled to sampling envelope 112 with a bellows-type connection or another X-Y adjustment mechanism, which may allow for movement of the torch envelope relative to the sampling envelope.

With continued reference to FIG. 1A, the torch assembly 100 further includes a gas injector 176 that extends from an inlet 176a that can receive an injector gas and an outlet 176b through which the injector gas can exit the injector 176 to reach a plasma zone 124 in which an inductively-coupled plasma can be formed. In addition, a sample for which an analytical analysis is required, e.g., via mass spectrometry, can be delivered via the inlet 176a of the injector 176 and can be delivered to the plasma zone 124 via the outlet 176b of the injector along the longitudinal axis 134 of the plasma torch assembly. For example, the injector gas flowing through the injector can carry the sample to the plasma zone. By way of example, the sample can be in the form of a suspension of small liquid droplets (e.g., about 1 to about 20 microns in diameter) or dry molecules or aerosols that are introduced into the injector can be carried by the gas to the plasma zone. By way of example, the source of the sample may be a nebulizer that can create aerosols of liquid samples (including samples with biological cells), a laser ablation system for supplying plumes of ablated material, or a gas chromatography effluent.

One or more analytes within the sample can be ionized or excited via passage through the plasma zone as a result of their interaction with the plasma. The ions or the excited species pass through the sampler orifice 128 to reach the downstream analytical instrument. Further, at least a portion of the injector gas can pass through the sampler orifice 128. In some cases, some or all of the injector gas passing through the sampler orifice 128 can be collected via a vacuum system of the analytical instrument and be returned to the plasma zone. Returned gas will likely require cleaning/scrubbing before it can be reused by the system.

As noted above, in a sealed torch according to various embodiments, the plasma can be self-ignited via application of the RF electromagnetic field at low pressures, which facilitates the use of shorter injectors in the torch assemblies. By way of example, in various embodiments, the injector can have a length in a range of about 5 mm to about 50 mm, e.g., in a range of about 5 mm to about 10 mm, or in a range of about 10 mm to about 20 mm, or in a range of about 20 mm to about 30 mm, or in a range of about 30 mm to about 40 mm, or in a range of about 40 mm to about 50 mm.

The boundary of the plasma zone 124 is depicted only for illustrative purposes and is not intended as depicting necessarily the actual boundary of the plasma zone. In particular, a plasma typically is not completely confined within a volume with sharp boundaries. Further, there are thermal gradients within an ICP. For example, the center of the plasma may be cooled via the injector flow, thus forming a “central channel” with the induction zone outside that channel being hotter, with heat from that zone flowing to the “central channel”.

In this embodiment, plasma torch assembly 100 includes a partition 180 in the form of a cylindrical structure. that is positioned between the injector 176 and the torch envelope 104. While in this embodiment the torch envelope 104, the injector 176 and the cylindrical structure 180 are concentrically positioned relative to one another, in other embodiments, one or more of these structures can be radially offset relative to one or more of the other structures. Further, as discussed in more detail below, in various embodiments, the injector can be movable in an X-Y plane, i.e., in a plane orthogonal to the longitudinal axis 134. Further, although the partition 180 is depicted as a cylindrical structure, other profiles, such as a truncated conical structure, may also be employed.

The positioning of the cylindrical structure 180 between the injector and the torch envelope provides a passageway (herein also referred to as a channel) 182 between an outer surface of the injector 176c and an inner surface 180a of the cylindrical structure 180 with an inlet 182a through which an auxiliary gas can be introduced into the passageway. The auxiliary gas can flow through the passageway 182 to reach the plasma zone 124. Another passageway 183 formed between an outer surface 180b of the cylindrical structure 180 and an inner surface 104a of the torch envelope provides another inlet 183a through which a vortex gas flow (herein also referred to as a plasma gas flow) can be introduced into the interior of the torch envelop. The vortex gas flow can help sustain plasma in the plasma zone 124 away from the inner surface of the torch envelope and can further facilitate maintaining the plasma close to the longitudinal axis 134 of the torch assembly.

In this embodiment, a single source of argon 168 (herein also referred to as Ar supply) supplies the injector, the auxiliary and the vortex gas. More specifically, the Ar supply 168 is fluidically connected to a gas manifold 172, which is in communication with the injector and the channels 182 and 183 via fluidic paths 156, 160, and 164 and distributes portions of the gas received from the Ar supply via the inlets 176a, 182a, 183a to the interior of the torch envelope. While in this embodiment the injector, the auxiliary and the vortex gases are the same (i.e., argon), in other embodiments, at least two of the gases can be different.

At least one coil 108, which can be, for example, in the form of a plurality of coils that are electrically connected in parallel is positioned external to the torch and surrounds at least a portion of the plasma zone 124. An RF power source 125 is in electrical communication with the coil 108 (herein also referred to as an RF coil 108) to apply an RF voltage thereto. The application of the RF voltage to the coil 108 results in generation of an RF electromagnetic field within at least a portion of the plasma zone. In various embodiments, prior to ignition of a plasma in the plasma zone, the pressure in the plasma zone is maintained at a low pressure, e.g., in a range of about 0.1 Torr to about 300 Torr, and the RF field is utilized to ignite the plasma without utilizing conventional ignition electrodes within the interior or exterior of the envelope 104. In other embodiments, rather than using the RF field for causing ignition, other mechanisms including, e.g., a DC or AC field triggering a breakdown in the presence of RF field can be employed. The ignition triggering fields can be supplied through additional structures commonly practiced for plasma ignition. With the sealed torch, a DC or AC field may be employed to ignite the plasma under low pressure conditions. A reduced pressure and the application of an RF field to the plasma zone allows the use of a lower DC or AC ignition voltage and power, thereby simplifying ignition circuitry and hence allowing the use of a cheaper and more compact ignition circuitry.

By way of example, and without limitation, the RF frequency can be in a range of about 1 MHz to about 10 GHZ, e.g., in a range of about 1 MHz to about 300 MHz. Further, the amplitude of the RF voltage can be, for example, in a range of about 50 V to about 6 KV, e.g., in a range of about 300 V to about 1 kV.

As noted, in various embodiments, the exhaust flow or at least a portion thereof can be recirculated back to the plasma zone. By way of example, FIG. 2 shows a plasma torch assembly 200 that is similar to the plasma torch assembly 100 discussed above, but further includes a recycling path 212, which is herein also referred to as a recycling line 212. The recycling path 212 is in fluid communication with the outlets of the exhaust channels 136 and 148 to receive the exhaust flow, which includes gases transferred into the torch assembly via the injector, the auxiliary and the vortex gas flow, from these channels. The recirculation path routes the received exhaust flow to a gas manifold 208 that in turn routes the gas(s) to the plasma zone. In addition to receiving gas from the recirculation path, the gas manifold 208 also receives gas (e.g., Ar) from gas supply (not shown in this figure) and distributes the gas received from the gas supply as the injector gas, the auxiliary gas and the vortex gas for delivery to the plasma zone.

In various embodiments, recycle line 212 and/or gas manifold 208 and a compressor 215 for compressing the exhaust gas may be within a housing for the torch envelope and/or housing for the control electronics for the RF voltage and/or gas flow. The housing may also include channels for cooling liquid.

By way of further illustration, FIG. 1B shows a cross-sectional cut through an image of a wall 300 of a sampling chamber, such as wall 116 discussed above in connection with FIG. 1A. Wall 300 defines a sampler orifice 304, which can be the same as the sampler orifice 128 depicted in FIG. 1A. The sampler orifice 304 may open to a sampling chamber. Wall 300 may also define aperture 308, aperture 312, and aperture 316. Aperture 308 may lead to channel 320. Aperture 312 may lead to channel 324. Channel 320 and channel 324 may function as the exhaust channels 136 and 148 discussed above to route a gas (e.g., argon) toward an exhaust handling system or to a recycling path.

Wall 300 also defines channels 328 and 332, which correspond to coolant channels 144a/144b, through which a coolant may be circulated through the wall. As the wall is formed of a conductive material, it can provide good thermal conductivity and hence allow the coolant to efficiently extract heat from the exhaust gas flowing in the channels 320 and 324.

Wall 300 may also define a groove 336 in which an O-ring can be seated to provide a seal for establishing a sealed connection between the wall 300 and a torch envelope of a plasma torch assembly, as discussed above. The sealed connection can be made by other suitable mechanisms, e.g., by brazing the torch envelope to the surface 300. Alternatively, a portion of wall 300 can be made from the same material as the torch. In various embodiments, the torch envelope and wall 300 can be formed a single unitary element, e.g., using 3D printing or machining a ceramic material. By way of example, aluminum nitride and/or Shapal may be particularly suitable for use in various embodiments due to their high thermal conductivity.

Referring again to FIG. 2, in various embodiments, a filter 214 can be placed in the recirculation path to filter the exhaust flow exiting through the channels 136 and 148 prior to their arrival at the gas manifold 172. The filter can separate argon, or other inert gas utilized for generating the plasma, from other discharge effluents for delivery to the plasma zone. Some examples of filters include, without limitation, a charcoal filter, a molecular sieve filter, or any other suitable filter, including those disclosed in PCT published Application No. WO 2018/154512 A1, which is herein incorporated by reference in its entirety.

In various embodiments, a compressor 215 can be placed in the recirculation path before and/or after the filter 214 to compress the recirculated gas prior to its delivery to the gas manifold 208. The compression of the gas can be achieved using a variety of different mechanisms. By way of example, a suitable pump such as a micro-turbine pump, a micro Scroll pump, a micro Roots blower, a diaphragm pump, a centrifugal blower may be utilized.

In various embodiments, the gas flowing through the sampler orifice that is received by an analytical instrument can be directed to an exhaust handling system, e.g., a fume hood, or can be compressed and stored for use in other applications as a lower grade gas, while the gas flowing through the exhaust channels 136 and 148 can be recycled via the recirculation path 212. Such an arrangement is herein referred to as “partial recycling,” In other embodiments, the gas flowing through the sampler orifice can be captured, filtered (e.g., using a filter similar to filter 214) and then returned back to the gas manifold, and the gas flowing into the exhaust channels 136 and 148 can also be recycled, optionally filtered, and compressed and returned to the gas manifold. Such an arrangement is which is herein referred to as full recycling. Such gas recycling arrangements allow for use of a much smaller gas supply 168, which can last in some cases for many months of operation.

FIGS. 1A, 1B, and 2 show the sampling orifice (sampler) (e.g., aperture 128 or aperture 304), exhaust channels (e.g., channels 136/148 or channels 320/324), and cooling channels (e.g., channels 144a/144b or channels 320/324) within an integrated piece. However, such components may be in separate pieces. For example, the sampling orifice, exhaust channel(s), and cooling channel(s) may be in three separate pieces, which may then be fastened together. In various embodiments, exhaust channel(s) and cooling channel(s) may be in one integrated piece and that piece may be fastened to a piece with a sampling orifice and also to the torch envelope. In various embodiments, exhaust channel(s), cooling channel(s), and the torch envelope may be integrated together as one piece and can be made out of the same material, for instance, machinable ceramic such as Shapal. In other embodiments, the torch envelope and the cooling channel(s) may be integrated together as one piece and the sampling orifice and the exhaust channel(s) may be integrated as another piece.

Although conventional plasma torches are limited to operating at the atmospheric pressure, the sealed connection between the torch envelope and the sampler wall in various embodiments of the present teachings provides flexibility in adjusting the operating pressure in the plasma zone. For example, as discussed above, the pressure can be reduced prior to ignition of the discharge to allow self-ignition using only the electromagnetic field provided by one or more RF coils. Further, after ignition, the pressure can be increased to a value greater than the atmospheric pressure. Thus, a torch assembly according to the present teachings can be operated over a large pressure range, e.g., a pressure range extending from about 0.1 to about 20 atm. The torch assembly may be configured to operate at pressures higher than the pressures generally used with semiconductor ICP processing. For example, the torch assembly may be configured to operate at pressures from about 0.1 to about 0.5, about 0.5 to about 1, about 1 to about 5, about 5 to about 10, or about 10 to about 20 atm. As a result of the different operating pressures, the torch envelope dimensions (e.g., wall thickness), sampling envelope dimensions (e.g., sampler orifice diameter, other aperture diameters), pump speeds, and/or flowrates may be different than at lower pressures (e.g., at 0.01 atm).

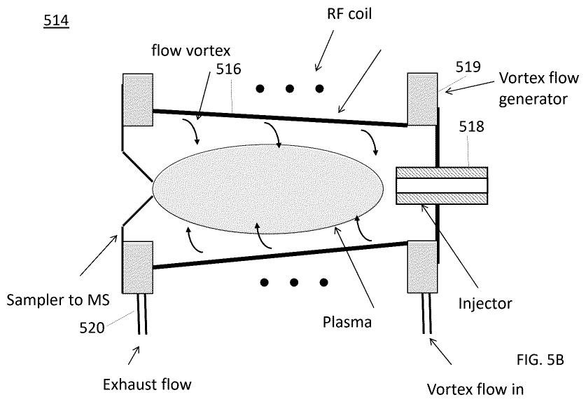

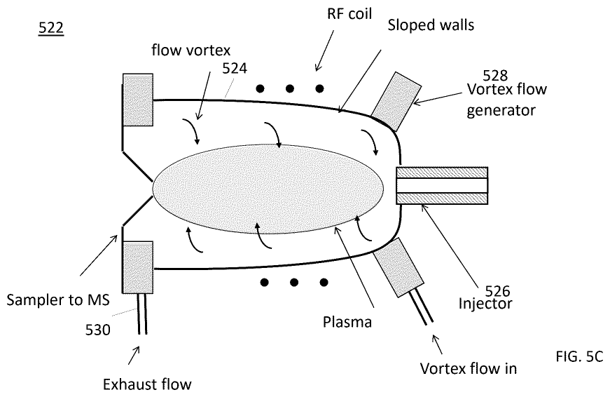

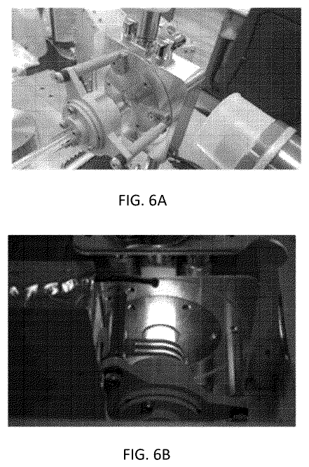

Torch assemblies may include any configurations described herein, including the ones shown in FIGS. 5A,5B, 5C and FIGS. 6A and 6B and FIGS. 8-14.

### Plasma Positioning

In the standard open air-type torch, the area where the sample ionization (e.g., for mass spectrometry) or excitation (e.g., for optical emission spectroscopy) occurs may be misaligned relative to the longitudinal axis of the torch. The reasons for the misalignment may include, for example, convective forces that pull the plasma upwards (in configurations where the torch axis is at an angle with respect to the direction of the gravitational force), imperfect symmetry of the load coil that may tilt the plasma relative to the axis, non-symmetrical introduction of argon into the torch, and imperfections of factors affecting the torch performance (injector inner tubing, injector tilt and offset, sampler orifice, plasma vortex, etc.). Therefore X-Y positioning of the ICP torches relative to the sampler orifice is important for maximizing the analyte signals and decrease the Ar and Ar₂ ion signals. In systems with conventional open air-type torches the X-Y positioning is usually performed by 2-dimensional mechanical movement of the torch against the sampler.

As explained previously, in a sealed torch according to various embodiments, the torch envelope is rigidly connected to the sampler wall, thus preventing the X-Y movement of the torch envelope relative to the sampler wall for alignment purposes. Although a movable seal may be utilized that would facilitate such X-Y adjustment, movable seal mechanisms can be complex and may be prone to failure. The inability to conduct such X-Y positioning seemingly makes a sealed torch configuration in which the torch envelope is rigidly connected to the sampler wall impractical. However, the present disclosure provides multiple approaches that can be employed to adjust the position of the optimal sampling region with respect to the sampling orifice of the sampler with sealed torches according to various embodiments.

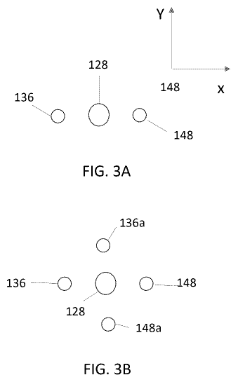

For example, with reference to FIGS. 1A and 1B and FIG. 3A, the position of the plasma relative to the longitudinal axis of the plasma torch can be adjusted by regulating the flow of the exhaust through the exhaust channels 136 and 148. As the exhaust channels 136 and 148 are positioned symmetrically relative to the sampler orifice 128 along the X axis, by changing the flow rate of the exhaust through these channels, i.e., by establishing a differential flow rate through these channels, the plasma can be moved along the X-direction. The valves 137 and 149 operating under the control of the controller 2000 can be utilized to adjust the flow rates through the exhaust channels 136 and 148. For example, the pressure differential may compensate for factors, such as asymmetry of the exhaust inlets relative to the sampler orifice or differences in flow conductance provided by the exhaust channels, among others.

With reference to FIG. 3B, in various embodiments, four exhaust channels 136, 148, 136a, and 148a are provided in the sampler wall to allow independent X and Y adjustment of the position of the plasma relative to the longitudinal axis of the torch assembly. For example, as shown in FIG. 3B, the inlets of the channels 136 and 148 may be symmetrically positioned relative to the sampler orifice along the X direction and the inlets of the channels 136a and 148a may be symmetrically positioned relative to the sampler orifice along the Y direction. The adjustment of the exhaust flow rate through the channels 136 and 148 can be utilized to adjust the position of the plasma along the X-direction and the adjustment of the exhaust flow rate through the channels 136a and 148a can be utilized to adjust the position of the plasma along the Y-direction. Such independent adjustment of the plasma can advantageously facilitate the optimization of analytical signals generated by a downstream analytical instrument, e.g., a mass spectrometer.

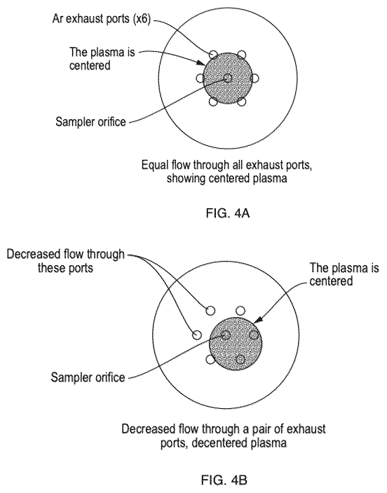

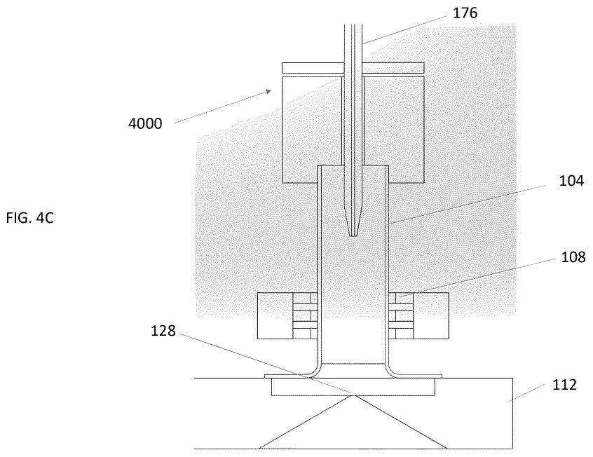

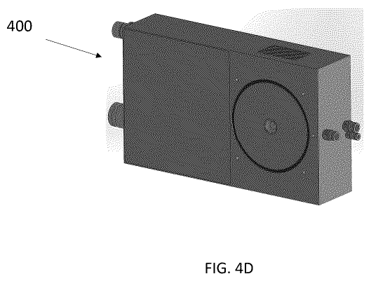

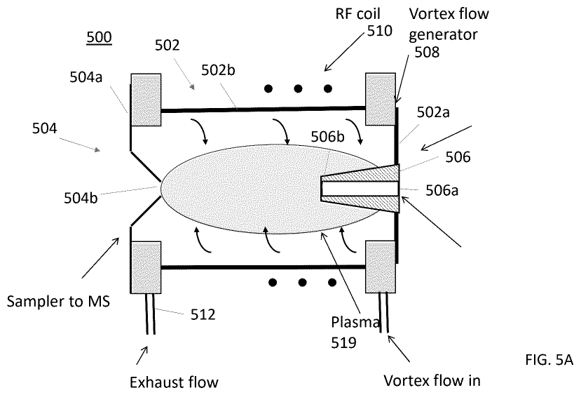

In various embodiments, more than four exhaust channels may be provided in the sampler wall, e.g., to provide additional degrees of freedom for adjusting the position of the plasma relative to the longitudinal axis of the torch assembly. By way of example, FIGS. 4A and 4B schematically demonstrate positioning of a plasma by adjusting exhaust flow through six exhaust channels distributed at the same radial distance about the sampler orifice. Each of the exhaust channels may be a channel similar to channels 136 or 148 discussed above in connection with FIG. 1A.

FIG. 4A shows a situation when the gas flow through the exhaust channels are substantially equal so as to center the plasma about the longitudinal axis and facilitate delivery of ions or excited species to the sampler orifice. In some cases, the plasma may not always be centered in such a situation, and the X-Y position may need to be adjusted to increase flow to the sampler orifice.

If the flow of argon in one of the exhaust channels is reduced, then the argon flow may deviate from the equilibrium flow in a direction that is opposite to the position of the exhaust channel through which the flow rate has been reduced. In this way, a pneumatic X-Y adjustment of the argon flow is possible. FIG. 4B shows decreased flow through two of the six exhaust channels. To regulate the exhaust gas flows individually, proportional valves can be installed at the exit of each individual exhaust channel, or the channels can be grouped so that two or more channels are regulated by one proportional valve.

A pneumatic X-Y adjustment of the position of the plasma as disclosed herein provides at least two advantages. First, it eliminates the need for mechanical X-Y adjustment, which is not possible when the torch envelope is rigidly sealed to the sampler wall and simplifies the mechanical construction of the torch. Second, in various embodiments, the valves and/or the regulators needed for adjusting the flow rate of the exhaust through the exhaust channels can be installed far from the sampler, e.g., connected to the sampler by flexible tubes. In this way, the control of the exhaust gas flows can be spatially separated from the torch. This allows independent development of the torch and the gas control system and simplifies exchange of the system components in case of any damage.

As noted above, in various embodiments of a sealed torch according to the present teachings, it is not feasible to move the torch envelope (herein also referred to as an outer jacket) relative to sampler wall. For example, such movement of the torch envelope may result in breakage of the seal. An alternative X-Y tuning of ion signals can be done by moving the injector (e.g., injector 176 in FIG. 1A) while maintaining the torch envelope(s) stationary. For example, as shown schematically in FIG. 4C, the injector (e.g., the injector 176) can be positioned on a movable platform 4000, e.g., an X-Y movement and tilt platform, that can move, e.g., to tilt or offset the injector relative to the longitudinal axis of the torch envelope 104 so as to optimize passage of ions generated through the interaction of a sample with the plasma into the sampler orifice 128 of the sampler wall 112 (similar to the previous embodiments, a plurality of RF coils 108 surrounds the torch envelope). In particular, the ions that pass through the sampler orifice generally originate from the central channel in the plasma. The central channel forms largely in response to the gas jet supplied from the injector. Thus, the position of the jet and its tilt can be utilized as parameters for adjusting the ion signal. These adjustments compensate for the above-mentioned factors that may shift the plasma from the axis.

Another way to simplify the X-Y adjustment is removing the causes of the displacement of the plasma from the axis. As mentioned before, in the standard open air-type torch, the displacement from the axis may result from convective forces and external air flows that can pull the plasma away from the longitudinal axis, imperfect symmetry of the load coil that can tilt the plasma relative to the longitudinal axis, asymmetrical introduction of argon into the torch, and imperfections (i.e., limits of precision with machining techniques) in the construction of the torch assembly. The introduction of the gases may be symmetrical, as with embodiments described herein. Further, in various embodiments, to eliminate the gravity effects, the ICP torch can be placed vertically. In various embodiments, a flat load coil can be used, which may be almost symmetrical and therefore reduce, and preferably eliminate, the tilting of the plasma. Therefore, in various embodiments, a combination of such approaches—vertical torch, flat symmetrical load coil, symmetrical introduction of argon—can reduce or remove the need for X-Y adjustment in a sealed torch assembly.

Furthermore, as discussed above, a sealed torch assembly can be implemented using a shorter envelope and/or a shorter injector, which can significantly reduce the need for X-Y adjustments that may occur, e.g., due to imperfections in construction of the torch assembly. Indeed, with injector and torch dimensions reduced, e.g., to ranges disclosed herein, the alignment of the parts can be sufficiently precise to eliminate the need for further optimization. For example, a shorter injector can be positioned more precisely inside the torch envelope so as to provide a precise alignment of the injector's outlet relative to the sampler orifice. A shorter torch tubing can also be made precisely, e.g., from a cylindrical or tapered piece of glass or ceramic. Thus, the plasma positioning and positioning of the central channel in the injector with respect to the sampling orifice can be made sufficiently precise.

In a vertical plasma arrangement, the axis of the injector may align with the axis of the torch envelope (e.g., longitudinal axis 134) and with the axis of the sampler. In the horizontal or tilted plasma arrangements, the injector position can be offset, or injector can be tilted to account for the chimney effect (gas flow resulting from differences in buoyancy between hot and cold air masses) under optimal operating conditions.

Because the torch envelope can be rigidly coupled to the sampling envelope, the torch envelope can also be rigidly coupled to the exhaust manifold and/or heat spreaders.

The sampler may consume almost all the plasma heat, decreasing the heat load on other elements of the system. Thus, in many embodiments, the heat management of the system can be achieved by primarily focusing on the heat management of the samplers. As discussed above, in various embodiments, the heat management can be provided by flow of a coolant through coolant channels provided in a sampler wall in which gas exhaust channels are also provided. In various embodiments, the gas exhaust channels and the coolant channels are in sufficient thermal communication, e.g., they have a sufficient area of overlap, for heat exchange, so that most of the plasma heat that is introduced into the sampler by the exhaust gas is transferred to the body of the sampler and then transferred to the coolant (e.g., water or other coolant, or a heat spreader including fins and/or fan(s)). Heat spreaders can include technologies such as heat pipes and planar heat piping surfaces. In this way, almost all the plasma heat can be managed and removed by the sampler. This reduces heat load on other components of the system.

Because almost all the heat from the plasma goes to the sampler, there is no hot exhaust to manage in other elements, and the overall remaining heat load on the analytical system is reduced. This relaxes thermal requirements for the instrument design. This, in-turn, can reduce number of mechanical fans in the system and therefore reduce vibrations which is critical for the example in mass cytometry microscope setup.

### Reduced Oxides and Gaseous Contaminants

In an open-air type torch, the argon is exhausted into the surrounding air. Although the argon flows directly through the analytical zone, diffusion of air from outside to the analytical zone is possible. This can lead to an increased formation of oxides of the metal analytes and leakage of gaseous contaminants from the air. In various embodiments, a sealed torch according to the present teachings can prevent the air diffusion into the torch assembly. As such, in various embodiments, no mixing of air and argon (or other gas used for a plasma) occurs. For example, the seal generated between torch envelope 104 and the sampler wall 116 as shown in FIG. 1A reduces, and preferably prevents, mixing of air with the gas for the plasma.

### Reduced Gas Exhaust

Embodiments of a plasma torch assembly according to the present teachings, such as those described herein, may greatly reduce gas exhaust from an instrument that utilizes such a torch assembly for ionization and/or excitation of analytes under study. For example, in various embodiments, only about 10-20 sLpm of nearly pure argon may be exhausted. In contrast, in an open-air type torch, the hot exhausted argon containing excited and ionized Ar species is mixed with the air. This can cause formation of harmful molecules like excited or ionized N₂, O₂, and NOₓ, O₃, HCN, CO, CO₂. To contain and remove this gaseous mixture, an enclosed chemical exhaust with an evacuation capacity of about 2000-4000 sLpm is typically used.

In contrast, in various embodiments of a sealed torch described herein, the argon or other gas that exits from the sampler is already cold and does not contain many or any excited or ionized species, such as those listed above. However, the sampler exit gas may still contain some products of reactions from the injected samples. However, such reaction products may be present at much lower amounts than the molecules formed from mixing air and the plasma in an open-air type torch because there is no mixing of air and the plasma. A small exhaust of cold argon of about 10-20 sLpm may be sufficient to exhaust the reaction products in a sampler of the sealed torch. Dry plasma operation (for instance, in laser ablation ICP-MS) is particularly attractive in combination with the sealed torch. In dry plasma mode, there is no bulk reagent entering the plasma such as water or a buffer that can contribute to production of harmful and corrosive species in the exhaust gas.

### Reduced Gas Consumption

As discussed above, in various embodiments, the exhausted gas (e.g., argon) can be reintroduced into the plasma, reducing total gas consumption, e.g., by a factor of about 5-10 times. In various embodiments, a sealed torch may consume about 10-20 sLpm of gas for the generation of the plasma. Approximately 2 sLpm of the gas may enter a vacuum pump associated with a downstream analytical instrument, e.g., a mass spectrometer, through the sampler orifice. The remaining 8-18 sLpm flow goes to the exhaust channels 136, 148. Because in the sealed torch, the exhausted gas is not mixed with air, this gas can be reintroduced into the plasma torch. For example, the recycling of the gas can be carried out as illustrated in FIG. 2. In this way, in various embodiments, the overall system (e.g., the plasma torch assembly and the downstream analytical instrument) may consume only that amount of argon that flows through the sampler and into the vacuum pump, e.g., about 2 sLpm in this example, and the total argon consumption may be reduced by about 5-10 times.

This mode of operation may be called partial recirculation because the gas exiting the sampler is not recirculated. In a full recirculation approach, the gas is recycled not only from the outer plasma gas e.g., exhaust gas passing through the exhaust channels, e.g., the exhaust channel 136 or channel 148 rather than through the sampler orifice, e.g., sampler orifice 128 shown in FIG. 1A but also from the gas that passes through the sampler orifice.

In many cases, the gas that passes through the sampler's orifice may be contaminated by the sample being analyzed. Thus, in various embodiments, a purification system may be employed to purify the gas (e.g., the argon gas) prior to its introduction via a recirculation path into the plasma zone. In the case of partial recirculation, purification of the gas (e.g., argon) may be minimal or even not required. In such cases, the complexity and cost of purification equipment may depend on the level of contamination of the outer plasma gas. In most cases, argon flow though the sampler exceeds the flow from the injector. Thus, most of the analytical flow carried by the injector is aspirated into the sampler and hence only a small fraction of analytical sample components may diffuse into the outer plasma gas flow.

Since in many cases, most of the contamination arises from the sample and the sample carrier fluid, the contamination may be largely restricted to the central channel of the plasma, which eventually is aspirated by the sampler. By way of example, in a typical operation state, about 1 sLpm of gas (e.g., argon) is supplied by the injector, and 2 sLpm is aspirated by the sampler. The sampler thus absorbs not only the injector flow but also some surrounding plasma, which may be contaminated by diffusion of sample material from the central channel. Still, the outer gas (e.g., argon or other outer gas) can be relatively clean.

As discussed above, if needed, the recirculated gas can be further purified (filtered) before it is reintroduced into the plasma zone, e.g., as the cooling plasma gas. Since in such a configuration, the plasma gas is not being wasted, in various embodiments, a higher flow rate of the vortex gas, e.g., a flow rate of about 50 sLpm, may be employed, e.g., to achieve a better cooling of the walls of the torch envelope. A high flow rate of the vortex gas (e.g., argon), e.g., a flow rate of about 50 sLpm, may increase the separation between the wall of the torch envelope and the induction zone in the plasma. This, in turn, may reduce the heat flow to the torch envelope.

Recirculation of argon may benefit from dry plasma operation (such as laser ablation or introduction of dry LIFT-ed material such as whole cells). In a dry plasma mode, the vortex gas flow (e.g., argon) is introduced into the torch assembly is less likely to be contaminated. Even if a small amount of another gas (e.g., helium) is introduced in the injector, a large portion of the other gas (e.g., helium) may stay in the central channel. The remaining portion may enter the gas that is being recycled. This remaining portion may be a small contribution to the overall gas (e.g., argon) in the recirculating flow, thus unlikely to change the properties of the induction zone significantly. Thus, the system can operate either as is or with a small adjustments to compensate for such an impurity that is recirculated back to the plasma zone.

### Eliminated Gate Valve

In various embodiments, a gate valve may not be required in an analytical instrument that receives ions or excited species from a sealed torch according to the present teachings. When an ICP torch is switched off, the plasma temperature rapidly decreases and the gas density near the sampler orifice rapidly increases. As a result, the mass flow through the sampler orifice may significantly (˜4×) increase. The mass flow through the vacuum system of a downstream analytical instrument, e.g., a mass analyzer, may also significantly increase. This mass flow may load the vacuum system beyond the capacity of the turbomolecular pumps and roughing pumps to maintain steady operation. A gate valve between the interface and the mass analyzer is usually installed with open-air type torches. The gate valve may be closed before the plasma is disabled.

In various embodiments of a sealed torch described herein, switching off the plasma can be performed with stopping or reducing the gas (e.g., argon) flowing into the torch. Because the torch is sealed from atmospheric air, in the plasma-off state, the interior of the torch envelope can be evacuated or partially evacuated, and hence no excessive gas load will be placed on the vacuum system of the downstream analytical instrument, e.g., a mass analyzer, thus eliminating the need for a gate valve.

In various embodiments, a dry sample may be ablated in an ablation cell and the products of the ablation may then be mixed with gas flow and sent through the injector. In various embodiments, a sample may be introduced in suspension, including droplets and aerosols. To prevent flow of gas through the injector, a mechanical plug can be used to block the input into the injector within the ablation cell. Alternatively, a mini-gate valve blade can be installed in the path of the injector. Even without the mini-gate valve, if the auxiliary and vortex flow are stopped, the only gas that will enter the torch will be the flow through the injector. However, the opening of the injector is usually smaller than the opening in the sampler.

Thus, the injector dimensions will limit the flow of gas into the vacuum system. For example, with a typical sampler inner diameter (ID) of 1 mm and an injector ID of 0.5 mm, the flow of the gas into the vacuum system will be 4 times lower when the sealed torch is installed versus the case of an open-air type torch. With the open-air torch, when the plasma is off, the air goes directly to the sampler, which in turn may overload the vacuum pumping system. In the sealed torch, the air is prevented from reaching the sampler orifice. Moreover, if the injector is connected to an ablation cell, which is also sealed, then without the plasma gases, the pressure in the ablation chamber may drop and result in virtually no load on the vacuum system without the plasma in operation. A sealed torch described herein permits this reduced load because the torch, the injector, and the ablation cell are part of a sealed vessel.

Control of vacuum pumps overload may be particularly simple in the system with recirculating outer plasma gas (outer vortex gas). In such a recirculating system, the flow rate of the gas (e.g., argon) into the sealed torch can substantially match the flow rate of the gas (e.g., argon) entering the sampler via its orifice (e.g., 2 sLpm) under normal plasma operation. If the plasma is off, the supply of the gas (e.g., argon) is maintained at the same flow rate, thus virtually no change to the pumping load will be created. In various embodiments, the recirculating flow of the vortex gas can be as high as 50 sLpm, but because the torch is a closed-circuit system, the flow does not contribute to the overall pressure in the torch. As discussed above, a closed-circuit system is sealed and can include partial recycling of the plasma (vortex) gas. With the plasma running, the pressure in the torch may be at a setpoint controlled by the flow rate, the temperature of the plasma, and the opening in the sampler. In operation, the pressure could be 1 atm or 1.2 atm or 0.8 atm or even 2-20 atm depending on the operator needs and the opening in the sampler. With the plasma off, the pressure in the torch enclosure may drop down to the level that balances the incoming flow from the mass flow controller (source) with the outgoing flow (sink) through the opening of the sampler.

Self-Igniting Plasma with RF Field

As discussed above, in various embodiments, no ignition electrodes and their electronics may be needed for igniting a plasma in a sealed torch according to the present teachings. In particular, the plasma can be self-ignited at low pressures using only an RF electromagnetic field generated by an RF coil supplied with RF power. In contrast, in an open-air type torch, the plasma cannot be automatically ignited when the argon or other gas is introduced into the torch, and the high voltage is applied to the load coil. In an open-air type torch, the pressure in the plasma zone is at or near atmospheric pressure, increasing the required breakdown voltage for igniting the plasma. To ignite the plasma usually a seed high voltage spark is used. The spark requires additional electrodes situated inside or outside the plasma torch, as well as electronics for the spark discharge.

In the sealed torch, the pressure of argon or other gas can be easily reduced down to few Torr. In such a low pressure, if the moderately high voltage is applied to the load coil, the plasma may be self-ignited. The moderately high RF voltage can be supplied by the RF power supply 125 when the pressure in the sealed torch is reduced. Therefore, no ignition electrodes or additional ignition electronics may be used in the sealed torch.

### Short Injector

In various embodiments, a short injector can be employed, e.g., as a result of the absence of the need for igniter hardware and/or mechanical X-Y adjustment, and/or the use of a compact solid state RF generator. For example, space for extra hardware is not needed between the sample and the torch. A short injector may result in faster arrival of a sample, e.g., laser ablation plumes, at the plasma and consequently less broadening of a resulting transient.

In various embodiments, the minimal length of a sealed torch according to the present teachings may be determined by the size of the load coil and can be estimated as the thickness of the coil plus the diameter of the coil turns, based on the rule of thumb (or modeling) of how external conductors interact with magnetic fields formed by the load coil and the plasma. A short injector can be installed in the sealed torch envelope and a sample to be introduced into the torch can be generated, e.g., as a laser ablation plume, near the torch. The distance from the laser ablation plume to the induction zone may be made as short as possible, such as from 0.5 cm to 1 cm or 1 cm to 5 cm. This, in turn, results in faster plume arrival times, and less broadening of the resulting plume transients.

By way of example, as discussed above, in various embodiments described herein, an injector having a length in a range of about 5 mm to about 50 mm can be used. By way of example, the use of an injector with a length of about 18 mm should result in a reduction of diffusional broadening of ablated plumes of about 20× compared to commercial ICP torch systems based on open-air torch designs used for laser ablation ICP MS applications.

Further, as discussed in more detail below, in various embodiments, the auxiliary gas flow can be eliminated, allowing moving the injector closer to the sampler orifice. In various embodiments, the injector can be installed on a metal base and can be formed of a metal injector or have a metal injector jacket to facilitate dissipation of plasma heat flowing into the injector. In some such cases, the injector can have a conical envelope with a reducing cross-sectional area from its inlet to its outlet to reduce any potential disturbance caused by metallic parts of the injector on RF fields while reducing the mass of the portions of the injector that are in closer proximity to the plasma, thereby providing more efficient heat management of the injector.

Independence from Atmospheric Pressure

The sealed torch described herein has an ICP pressure independent of atmospheric pressure, enhancing reproducibility of the measurements and making measurements independent of altitude of the instrument.

In an open-air type ICP torch, the exhaust argon exits to an open atmosphere. As a result, gas pressure in the plasma may be equal to atmospheric pressure or depend on atmospheric pressure. Atmospheric pressure may change, e.g., day to day, and may depend on the altitude of the instrument operating site. These changes reduce reproducibility of the measurements. The temperature of the plasma and the amount of sampled gas (e.g., argon) may both vary depending on the pressure in the torch. In various embodiments of a sealed torch described herein the pressure can be controlled independently of atmospheric pressure. In this way, reproducibility of the measurements can improve. Further, once the plasma is ignited using the RF coil(s), the pressure in the plasma torch may be increased above atmospheric pressure, e.g., to avoid ingress of contaminants from external air. The operation of a sealed torch according to the present teachings is not, however, limited to pressures above atmospheric pressure. Rather, in various embodiments, a sealed torch according to the present teachings can be operated at or below atmospheric pressure. Still, in some circumstances, operating significantly above 1 atm may be preferred to increase the density of the plasma.

With reference to FIG. 4D, in various embodiments, the sealed torch assembly can be housed within a housing 400. The housing 400 can be formed, e.g., of a metal to protect the sealed torch assembly and the RFG from radiating electromagnetic interference. Further, cooling channels can be formed in the housing. The passage of a cooling fluid, e.g., water, through such cooling channels can dissipate the heat generated by the torch plasma and/or other system components.

In various embodiments of a sealed torch assembly according to the present teachings, the auxiliary gas flow can be eliminated. This allows a more compact construction of the torch assembly, as discussed below. For example, FIG. 5A is an illustration of the cross section of a sealed torch 500, which includes a torch envelope 502 in the form of a cylindrical tube that includes a back wall 502a and a cylindrical lateral wall 502b. Similar to the previous embodiments, the torch envelope 502 is rigidly connected to a wall 504a of a sampler 504 around an orifice 504b of the sampler envelope via a sealed connection.

A conically-shaped injector 506 is placed in the enclosure provided by the torch envelope 502. The injector 506 extends from an inlet aperture 506a through which a gas carrying a sample can be introduced into the injector to an outlet aperture 506b through which the gas in which the sample is entrained can exit the injector to enter a plasma zone.

A vortex generator 508 is coupled to the torch envelope 502 and receives a vortex gas (which can be the same as or different from the injector gas) from a gas supply and delivers the gas to the radially outer portion of the interior of the torch envelope 502. The gas flow delivered by the vortex generator exhibits a plurality of vortices that can help confine a plasma generated in the plasmas zone (shaded area) close to a longitudinal axis of the torch envelope.

One or more RF coils 510, such as the RF coils described above, surround a portion of the torch envelope. An RF power supply (not shown in this figure) applies RF power to the coils to generate an RF electromagnetic field in the plasma zone. Similar to the previous embodiments, the RF coils can be utilized to ignite a plasma 519 in the plasma zone at a low pressure. Subsequent to the ignition of the plasma, the pressure within the torch envelope may be increased while the RF electromagnetic field helps sustain the plasma.

The injector gas exiting the injector carries a sample of interest through the plasma, where one or more analytes within the sample are ionized and/or exited. The gas flow further carries the ions and/or the excited species through the orifice 504b to an analytical zone of a downstream analytical instrument, e.g., a mass spectrometer.

An exhaust channel 512 is in fluid communication with the interior of the torch envelope to remove the vortex gas and any potential plasma effluents that may have been mixed with the vortex gas from the torch envelope. The majority of the vortex gas exits the torch envelope via the exhaust channel 512. Similar to the previous embodiments, the exhaust gas may be recirculated or may be disposed of without recirculation.

There are significant structural differences between the torch assembly 500 and a conventional torch assembly. For example, the sealed connection between the torch assembly and the sampler wall allows shortening the axial length of the torch assembly. By way of example, in various embodiments, the axial distance between the back plate of the torch assembly and the orifice of the sampler envelope can be equal or less than about 3× of an inner diameter of the torch envelope. This in turn allows shortening the length of the injector and lowering the axial distance between the outlet of the injector and the orifice. By way of example, the injector's length can be in a range of about 5 mm to about 50 mm and the distance between the outlet of the injector and the orifice can be in a range of about 5 mm to about X40 mm. In addition, in this embodiment, the injector is fully enclosed within the interior of the torch assembly such that a portion of the injector protrudes into the plasma. The conical shape of the injector helps reduce the heating of the injector by the plasma. Further, at least a portion of the injector, e.g., the outer surface, can be formed of a material exhibiting good thermal conductivity, e.g., a metal, that can facilitate heat dissipation and hence allow the injector to withstand the high plasma temperatures to which it is exposed.

The close proximity of the backwall of the torch envelope to the plasma as well as the conical shape of the injector and its positioning relative to the orifice of the sampler envelope facilitates thrusting the plasma forward towards the sampler where ions and/or excited species of interest can be introduced into a downstream analytical instrument.

By way of further illustration, FIG. 5B schematically depicts a cross-sectional view of another embodiment 514 of a torch assembly according to the present teachings, which does not employ an auxiliary gas flow. Similar to the previous embodiment, the torch assembly 514 includes a torch envelope 516 that is rigidly sealed to a wall of a sampler around the sampler's orifice. It also includes an injector 518 for injecting an injector gas that can carry a sample to a plasma generated within the plasma zone, and a vortex generator that can generate a vortex gas flow in the outer radial portions of the torch envelope, which can help confine the plasma in proximity of a longitudinal axis of the torch envelope. Further, similar to the previous embodiments, an exhaust channel 520 is in fluid communication with the interior of the torch envelope for removing the majority of the vortex gas introduced into the torch envelope.

Unlike the previous embodiments, the torch envelope has a truncated conical profile with an expanding cross-section toward the sampler's orifice, which can help thrust the plasma toward the sampler's orifice. Further, in this embodiment, the injector is not fully contained within the enclosure provided by the torch envelope. Rather, it protrudes partially into the interior of the torch envelope. As a result, though close to the plasma, the injector does not protrude into the plasma. In addition, the injector has a cylindrical profile. The conical shape of the injector and the closer proximity of the wall 502a to the sampler orifice can collectively eliminate the need for the auxiliary gas.

FIG. 5C shows another example of a plasma torch assembly 522 according to embodiments in which an auxiliary gas flow is not utilized. The plasma torch assembly 522 includes a torch envelope 524 that is connected via a rigid seal to an envelope of a sampler, an injector 526, a vortex generator 528, and an exhaust channel 530. Similar to the previous embodiments, the distance between the back plate of the torch envelope to the sampler orifice is shortened relative to conventional systems. Further, the injector's outlet is closer to the sampler orifice than in conventional systems. In this embodiment, the injector partially protrudes into the interior of the torch envelope and has a cylindrical profile. The torch envelope has a curved profile with a varying radius of curvature, which decreases in a non-linear fashion from the end of the torch envelope that is rigidly sealed to the sampler envelope to the end that is coupled to the injector. The sloped profile of the torch envelope is such that the cross-sectional area of the torch envelope increases from the end coupled to the injector to the end that is rigidly sealed to the sampler envelope. More generally, the cross section of the torch envelope (R) can vary in a suitable manner as a function of distance (z) along the longitudinal axis of the torch envelope. The sloped profile of the torch envelope helps direct the vortex flow in a manner that can efficiently confine the plasma in close proximity of the longitudinal axis of the torch envelope and to thrust the plasma toward the sampler orifice.

### EXAMPLES

### Example 1

FIG. 6A shows an image of a sealed plasma torch assembly according to an embodiment. FIG. 6B shows the sealed plasma torch assembly of FIG. 6A with plasma on and the load coil visible.

### Example 2

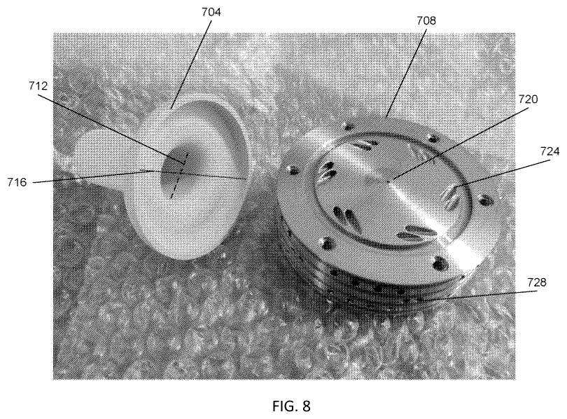

FIG. 8 shows an image of a torch envelope 704 and a sampling envelope 708. Torch envelope 704 is made of a ceramic and has a trumpet-like shape. Torch envelope 704 has a section with an inner diameter 712 and flares out from inner diameter 712 to a larger inner diameter 716. In this case, the length of the section of the torch envelope with inner diameter 712 is about 80% of the total length of the torch envelope 704. In general, the length of the section of the torch envelope with inner diameter 712 may be 99% to 90%, 90% to 80%, 80% to 70%, 70% to 60%, 60% to 50%, 50% to 40%, 40% to 30%, 30% to 20%, 20% to 10%, or 10% to 1% of the total length of torch envelope 704. Sampling envelope 708 includes sampling orifice 720 and aperture 724 to an exhaust channel. Several outputs of exhaust channels 724 are shown with sampling envelope 708, including exhaust output 728.

### Example 3

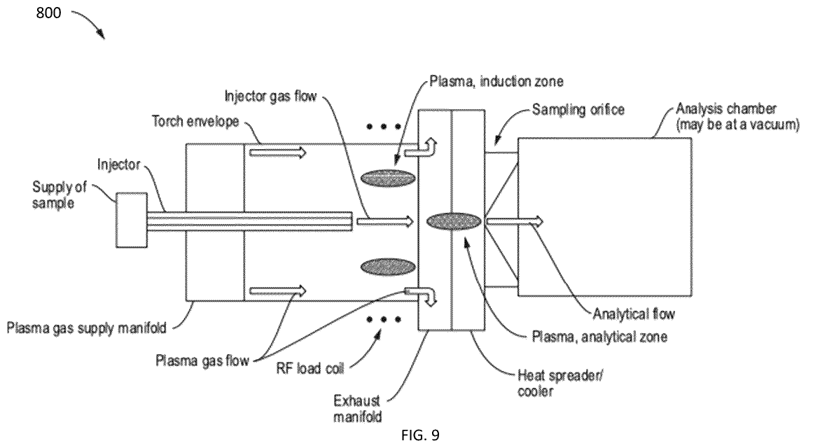

FIG. 9 shows a diagram of a sealed torch assembly 800, which includes a supply (i.e., source) of sample for analysis. The supply of sample can be via a nebulizer for creating aerosols of liquid samples (including samples with biological cells); a laser ablation setup for supplying plumes of ablated material; or a gas chromatography effluent.

Sealed torch assembly 800 also includes an injector for supplying a sample, e.g., in the form of aerosols and gaseous matter containing the carrier gas and the sample in the form of particles, molecules, and/or atoms.

Also shown is a plasma gas supply manifold. A purpose of this gas supply manifold is to form a desired pattern of gas flow that supports a desired induction zone (e.g., plasma zone) and cooling in a torch envelope of the sealed torch assembly 800. The torch envelope may be an enclosure that confines the plasma and prevents its contact with the outside environment (e.g., air).

Sealed torch assembly 800 includes an RF load coil for generating an RF electromagnetic field for igniting and sustaining the plasma.

Sealed torch assembly 800 also includes an exhaust manifold for removing a large portion of the gas supplied by the plasma gas manifold.

The system may also include a heat spreader/cooler for removing heat generated by the power imparted into the plasma via the RF load coil.

A sampling orifice is shown in a sampling envelope. The sampling envelope is an element that separates plasma torch zone (including its analytical zone) from analysis chamber (also a sampling chamber). The sampling orifice allows for the passage of sample (analytical flow) from analytical zone into an analysis chamber, which may be a vacuum chamber with ion optics for ICP-MS and mass cytometry. The analysis chamber may be a chamber at or around an atmospheric pressure for analysis such as ICP-OES.

### Example 4

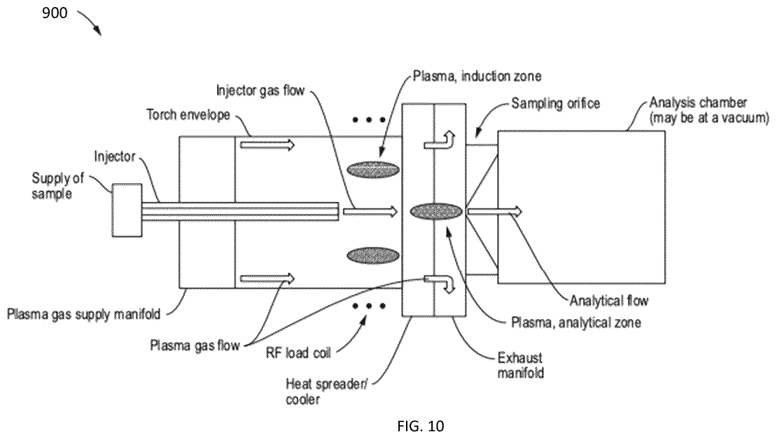

FIG. 10 shows a schematic diagram of a sealed torch assembly 900, which has the same components as sealed torch assembly 800. However, FIG. 10 shows how the modular connections can be interchanged. Sealed torch assembly 900 has the order of positioning along the axis for the heat spreader/cooler and the exhaust manifold reversed compared to sealed torch assembly 800.

### Example 5

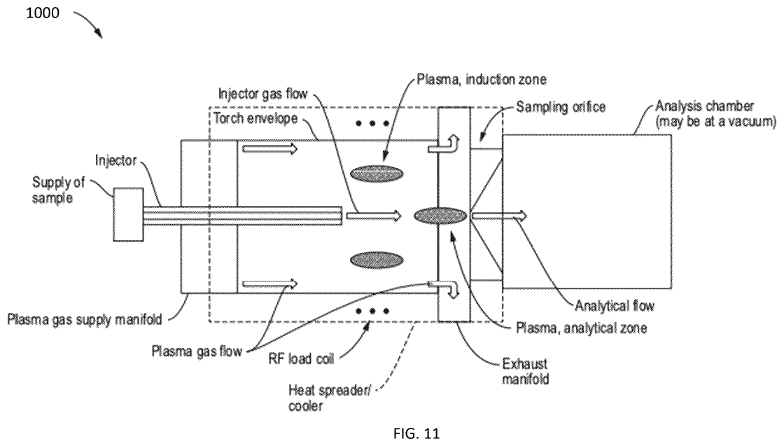

FIG. 11 shows a diagram of a sealed torch assembly 1000. Sealed torch assembly 1000 has the same components as sealed torch assembly 800. FIG. 11 shows an embodiment where the heat spreader (shown as dashed lines) is extended and engulfs the gas supply manifold, the load coil, the torch envelope and the sampling envelope.

### Example 6

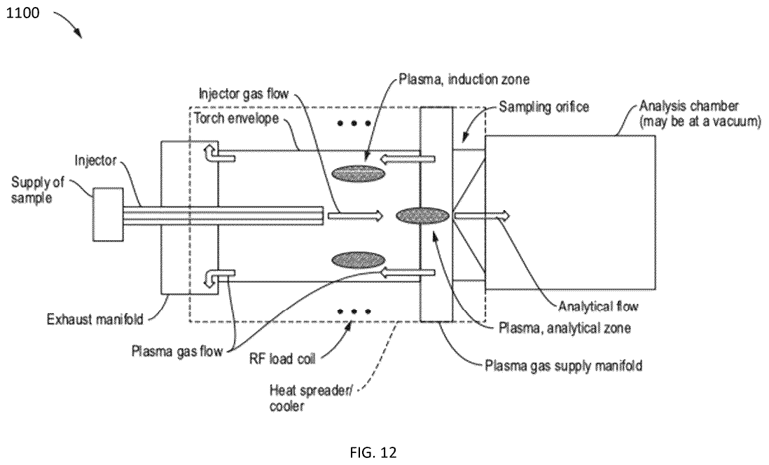

FIG. 12 shows a diagram of a sealed torch assembly 1100. Sealed torch assembly 1100 has the same components as sealed torch assembly 800. Sealed torch assembly 1100 has the positions of the gas supply and the exhaust reversed compared to sealed torch assembly 800.

### Example 7

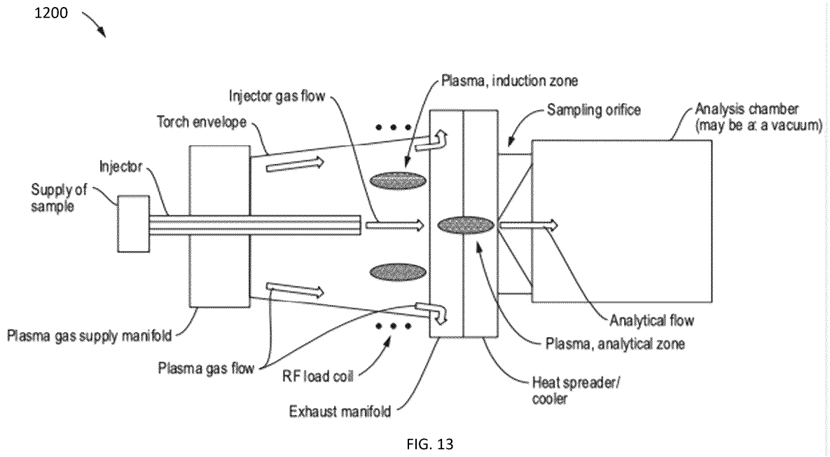

FIG. 13 shows a diagram of a sealed torch assembly 1200. Sealed torch assembly 1200 has the same components as sealed torch assembly 800. However, sealed torch assembly 1200 has a torch envelope that is not cylindrical in shape. In sealed torch assembly 1200, the torch envelope has a truncated conical shape.

### Example 8

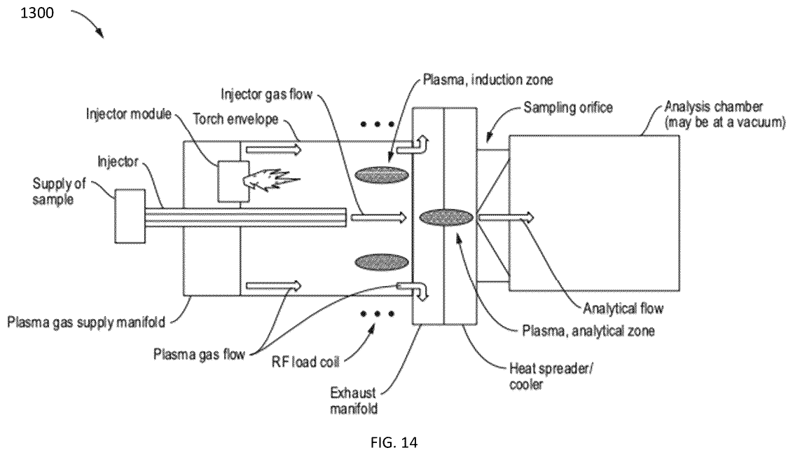

FIG. 14 shows a diagram of a sealed torch assembly 1300. Sealed torch assembly 1300 has the same components as sealed torch assembly 800. In addition, sealed torch assembly 1300 includes an igniter module. The igniter module may be used to start the plasma. As described herein, the ability to seal the plasma chamber creates an opportunity for self-ignition of the plasma using the RF field of the load coil. Thus, the igniter module can be redundant and is optional. Removing the igniter module results in a simpler and more compact setup. Sealing the torch allows for the operation of the igniter at reduced pressure which reduces igniter voltage and power requirements and simplifies mechanical and electrical setup of the igniter. Thus, if self-ignition by RF is not available due to constrains of RF power source, the ignition with an igniter at a lower pressure, enabled by the sealed torch, reduces the impact of length of the torch assembly and the cost of the system.

Sealed torch assemblies shown in FIGS. 6A and 6B and FIGS. 8-14 or portions thereof may be used in plasma torch assembly 100 of FIG. 1A or plasma torch assembly 200 of FIG. 2.

### II. Methods

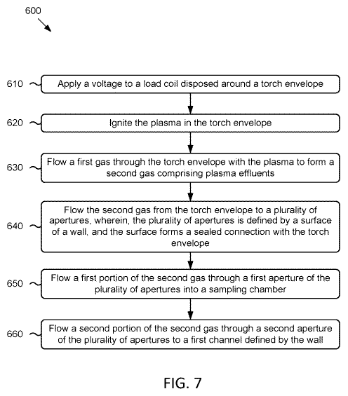

FIG. 7 is a flowchart of an example process 600 associated with embodiments of methods of analysis using a plasma in a sealed plasma torch. In some implementations, one or more process blocks of FIG. 6 may be performed by an assembly (e.g., plasma torch assembly 100). In some implementations, one or more process blocks of FIG. 6 may be performed by another device or a group of devices separate from or including the assembly. Additionally, or alternatively, one or more process blocks of FIG. 6 may be performed by one or more components of plasma torch assembly 100.

At block 610, a voltage is applied to a coil disposed around a torch envelope. By way of example, the coil may be coil 108 and the torch envelope may be torch envelope 104 discussed above in connection with FIG. 1A. For example, a power supply may apply a voltage to the coil disposed around the torch envelope. The power supply may be an RF generator. Applying the voltage may consume a power in a range of 0.2 to 1 kW, 1 to 1.5 kW, 1.5 kW to 2 kW, or greater than 2 kW. A gas is introduced into the interior of the torch envelope and the pressure of the interior of the torch envelope is maintained, e.g., in a range of about 0.0001 atm. to about 0.4 atm. In other cases, the ignition of the plasma can be achieved at a higher pressure, e.g., pressures in a range of 1 to 5 atm, including conventional pressures, by using igniters that can operate at such pressures.

At block 620, the plasma is ignited in the torch envelope by applying the RF voltage to the coil. For example, the voltage applied to the coil may ignite the plasma in the torch envelope, as described above. The plasma may be ignited at a pressure in a range from about 0001 to about 0.1, about 0.01 to about 0.1, about 0.1 to about 0.5, about 0.5 to about 1, about 1 to about 5, about 5 to about 10, or about 10 to about 20 atm. During process of igniting the plasma, the pressure may be at any of the pressures described for ignition. Igniting the plasma may not need to include applying a voltage to a conventional ignition electrode inside the torch envelope. For example, with the sealed torch the plasma may self-ignite via the voltage applied to the RF coil when the pressure in the sealed torch is reduced to a sufficiently low level.

At block 630, a first gas (e.g., argon) is flowed through the torch envelope, where the gas can carry a sample to the plasma so as to cause its ionization or excitation. The passage of the gas carrying the sample can generate plasma effluents. The first gas may flow through the torch envelope at a flow rate from about 0.1 to about 2 sLpm, about 2 to about 5 sLpm, about 5 to about 10 sLpm, about 10 to about 50 sLpm, or greater than 50 sLpm. The flowrate of the first gas may be the flow through the injector (e.g., injector 176 in FIG. 1A) or the total flowrate of the gas through torch envelope 104 (e.g., all gas going to the torch envelope via the fluid paths 156, 160, and 164 depicted in FIG. 1A). The first gas may include argon, helium, or any noble gas. The first gas can also be nitrogen or hydrogen or some other suitable gas for maintaining plasma. In various embodiments, the first gas may exclude oxygen or nitrogen, including the ratio present in air. The first gas may exclude air. The plasma effluents can include atoms, ions, and radicals of the first gas and/or a sample entrained in the first gas.

The first gas may be introduced to the torch envelope by flowing a first portion thereof through an injector (e.g., injector 176) centered on the longitudinal axis (e.g., longitudinal axis 134) of the torch envelope. In various embodiments, a sample to be analyzed may be flowed through the injector along with the first portion of the first gas. Plasma effluents may include ionized and excited species from the sample. A second portion of the first gas may be flowed through an annular region between the torch envelope and the injector. The annular region may be supplied with the gas via the fluid path 160 and/or the fluid path 164 depicted in FIG. 1A.

At block 640, the gas introduced into the torch envelope (herein also referred to as the second gas) is flowed to a plurality of apertures. The plurality of apertures may be defined by a surface of a wall. The surface may form a sealed connection with the torch envelope. The wall may be wall 116 and the surface may be surface 120 depicted in FIG. 1A.

At block 650, a first portion of the second gas is flowed through a first aperture of the plurality of apertures into a sampling chamber. The first aperture may be the sampler orifice 128 or any sampling orifice described herein. The first portion of the first gas flowing through the first aperture may have a flowrate of about 0.1 to about 0.5 sLpm, about 0.5 to about 1 sLpm, about 1 to about 2 sLpm, or about 2 to about 5 sLpm.

At block 660, a second portion of the second gas may be flowed through a second aperture of the plurality of apertures to a first channel defined by the wall. The first portion of the second gas may have a greater proportion of the plasma effluents than the second portion of the second gas. The second portion of the second gas may include gas that did not pass through the plasma. The first aperture may be closer to the center of the torch envelope than the second aperture or other apertures of the plurality of apertures.

In various embodiments, process 600 may include increasing the amount of plasma effluents passing through the first aperture by adjusting a flowrate of the second gas through the second aperture. The positioning of the plasma relative to a longitudinal axis of the torch assembly so as to optimize the passage of the plasma effluents through the sampler orifice may be performed as described in connection with FIGS. 4A and 4B. One or more of the flowrates through apertures other than the first aperture may be adjusted (e.g., by a valve or mass flow controller). Decreasing the flow rate through an aperture may move the greatest concentration of plasma effluents away from the aperture. Increase in the flow through an aperture may move the greatest concentration of plasma effluents toward the aperture.

In various embodiments, process 600 may include recirculating (recycling) the second portion of the second gas back to the plasma. By way of example, the recirculation may be performed as described with FIG. 2. In various embodiments, the recirculated gas may be further purified to remove contaminants before recirculating to the plasma.

In various embodiments, process 600 may include flowing a coolant through a cooling channel formed defined by the wall of a sampler orifice. In various embodiments, process 600 may include cooling the temperature of the wall to 100° C. or lower, including 80° C. or lower, 60° C. or lower, 40° C. or lower. The coolant may include water, glycol, or any other suitable coolant.

In various embodiments, process 600 may include flowing a remaining portion of the second gas through the remaining apertures of the plurality of apertures. The flowrate of the second portion of the second gas and the remaining portion of the second gas may be in a range from 2 to 50 sLpm.

Process 600 may include additional implementations, such as any single implementation or any combination of implementations described below and/or in connection with one or more other processes described elsewhere herein.

In various embodiments, the first portion of the second gas may contact a sample after flowing through the first aperture. More typically, the first portion of the second gas may contact the sample before flowing through the first aperture, e.g., the sample can be carried by the injector flow into the plasma zone. The first portion of the second gas may react with the sample. In various embodiments, the first portion of the second gas may contain particles originated from the ablated sample. In various embodiments, the first portion of the second gas may contain particles in a suspension. The result of any reaction of the first portion of the second gas with the sample may be analyzed, including by mass spectrometry or optical emission spectroscopy. Sampling methods include Imaging Mass Cytometry™ and suspension mass cytometry.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects

The above description of example embodiments of the invention has been presented for the purposes of illustration and description. It is not intended to be exhaustive or to limit the invention to the precise form described, and many modifications and variations are possible in light of the teaching above.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Additionally, details of any specific embodiment may not always be present in variations of that embodiment or may be added to other embodiments.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither, or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a method” includes a plurality of such methods and reference to “the sample” includes reference to one or more samples and equivalents thereof known to those skilled in the art, and so forth. The invention has now been described in detail for the purposes of clarity and understanding. However, it will be appreciated that certain changes and modifications may be practice within the scope of the appended claims.

All publications, patents, and patent applications cited herein are hereby incorporated by reference in their entirety for all purposes. None is admitted to be prior art.

1. A plasma torch assembly, comprising:
an envelope surrounding a plasma zone,
a sampling chamber including a wall having at least one sampler orifice for providing a fluid communication between the plasma zone and the sampling chamber, and
a seal for providing a sealed connection between the envelope and said wall of the sampling chamber around said at least one sampler orifice.

2. The plasma torch assembly of claim 1, wherein said seal is configured to rigidly connect said envelope to said wall.

3. The plasma torch assembly of claim 1, further comprising an injector extending from a first inlet for receiving an injector gas to a first outlet for delivering at least a portion of the injector gas to the plasma zone.

4. (canceled)

5. The plasma torch assembly of claim 1, further comprising a tubular structure positioned between the injector and an inner surface of the envelope and at least partially surrounding the injector so as to define a second inlet for delivering an auxiliary gas to a region between an outer surface of the injector and an inner surface of the tubular structure, said tubular structure further defining a third inlet for delivering a vortex gas to a region between an outer surface of the tubular structure and an inner surface of the envelope.

6. (canceled)

7. The plasma torch assembly of claim 5, wherein said injector gas, said auxiliary gas and said vortex gas are the same gas and are supplied via a single gas supply.

8. (canceled)

9. The plasma torch assembly of claim 1, further comprising at least one RF coil disposed at least partially around the envelope.

10-11. (canceled)

12. The plasma torch assembly of claim 9, wherein said at least one RF coil has a split-coil structure having two or more segments that are mechanically coupled to one another so as to surround said envelope and are electrically coupled to provide an electrical path between the two or more segments.

13-14. (canceled)

15. The plasma torch assembly of claim 9, further comprising a radiofrequency (RF) source in electrical communication with said at least one RF coil for generating an RF field within at least a portion of the plasma zone for igniting the plasma.

16-17. (canceled)

18. The plasma torch assembly of claim 1, further comprising at least one exhaust channel formed in said wall and extending from an inlet aperture to an outlet aperture, wherein said inlet aperture is in fluid communication with the plasma zone.

19. The plasma torch assembly of claim 18, further comprising at least one exhaust valve operably coupled to said outlet aperture of said at least one exhaust channel for controlling an exhaust flow exiting the exhaust channel.

20. The plasma torch assembly of claim 19, further comprising at least one regulator coupled to said at least one exhaust valve for adjusting a flow rate of the exhaust exiting the exhaust channel,
wherein said at least one regulator is configured to adjust said exhaust flow rate so as to optimize flow of ionic or excited species from the plasma zone into the sampler orifice.

21-23.

24. The plasma torch assembly of claim 20, wherein said least one exhaust channel comprises two or more pairs of channels, wherein each of said pairs is configured to allow adjusting position of the plasma along a different dimension via adjusting flow rates of exhaust gas through said channels of the pairs.

25-27. (canceled)

28. The plasma torch assembly of claim 18, further comprising at least one recirculation path fluidically coupled to said at least one exhaust channel for returning at least a portion of the gas delivered to the plasma zone back to the plasma zone.

29-30. (canceled)

31. The plasma torch assembly of claim 1, further comprising at least one cooling channel formed in said wall and configured to receive a coolant.

32-45. (canceled)

46. The plasma torch assembly of claim 3, wherein said injector is movable, relative to said sampler orifice, in a plane orthogonal to a longitudinal axis of the torch assembly, along said longitudinal axis of the torch assembly, or in said plane and along said longitudinal axis.

47-63. (canceled)

64. A method for producing an inductively coupled plasma in a plasma torch having a torch envelope sealingly coupled to a wall of a sampler of an analytical instrument, the method comprising:
introducing an inert gas into an interior of said torch envelope,
maintaining a pressure of the interior of the torch envelope below about 4×104 Pa,
establishing a radiofrequency (RF) field in at least a portion of said interior of the torch envelope so as to ignite a plasma in said gas.

65. The method of claim 64, further comprising increasing a pressure of the interior of said torch envelope above 4×104 Pa.

66. (canceled)

67. The method of claim 64, further comprising utilizing an injector for introducing a sample via a carrier gas into said plasma.

68. The method of claim 67, further comprising adjusting position of the plasma relative to a longitudinal axis of the torch assembly via adjusting a tilt of the injector relative to said longitudinal axis.

69. The method of claim 64, further comprising adjusting position of said plasma relative to a longitudinal axis of said plasma torch via adjusting flow rate of an exhaust gas passing from the plasma zone to one or more exhaust channels provided in the wall of the sampler.

70-85. (canceled)
